(19) United States
(12) Patent Application Publication
(10) Pub. No.: US 2025/0230018 A1
(43) Pub. Date: Jul. 17, 2025

(54) Multi-car elevator

(71) Applicant: Soon Gil Jang, Seoul (KR)

(72) Inventor: Soon Gil Jang, Seoul (KR)

(21) Appl. No.: 19/015,908

(22) Filed: Jan. 10, 2025

(30) Foreign Application Priority Data
Jan. 15, 2024 (KR) 10-2024-0006274
May 13, 2024 (KR) 10-2024-0062358
Jan. 8, 2025 (KR) 10-2025-0002650

(51) Int. Cl. B66B 11/00

(52) U.S. Cl. CPC B66B 11/0095

(57) ABSTRACT

According to the present invention, a single counterweight is used for a plurality of cars of a multi-car elevator installed in a single elevator shaft to provide a counterweight function with the same weight to the cars, or counterweights equal in number to the plurality of cars are used. A counterweight rope of single counterweight, which connects the cars, may be connected to a car rope or a car pulley. All the ropes are disposed on imaginary radial straight lines disposed in different directions based on a center vertical line of the car. The multi-car elevator according to the present invention uses a minimum space. The multi-car elevator may be implemented by minimally changing an elevator in related art.

### TECHNICAL FIELD

In the case of an elevator in the related art, a single car is generally operated in a single elevator shaft. A multi-car elevator refers to an elevator in which a plurality of cars is operated in a single elevator shaft. When the multi-car elevator is operated, the efficiency of the elevator may be significantly improved. The technology related to the multi-car elevator has been developed but has not yet reached a practical step.

### BACKGROUND ART

A multi-car elevator in the related art has difficulty in installing counterweights that suit a plurality of cars. This is because there is no practical method capable of moving the plurality of counterweights in a single elevator shaft while preventing the plurality of counterweights from colliding with one another. Because the solution of widening the elevator shaft causes a problem of an increase in costs, this solution cannot be taken into consideration. Because there is no practical method of operating the plurality of counterweights, even a method of connecting the counterweights to the cars cannot be taken into consideration.

### SUMMARY OF THE INVENTION

### Technical Problem

An object to be achieved by the present invention is to provide counterweights or counterweight functions required for a plurality of cars to operate the plurality of cars in a single elevator shaft.

Another object to be achieved by the present invention is to provide a method of connecting a counterweight and a rope to a plurality of cars and provide a method of operating the plurality of cars.

### Technical Solution

In the present invention, different technical solutions are used depending on a case in which counterweights equal in number to a plurality of cars are used and a case in which a single counterweight is used.

In case that the single counterweight is used, one or more counterweight pulleys are installed as movable pulleys on the counterweight, and a single counterweight rope is used for the one or more counterweight pulleys. The one or more counterweight pulleys are the movable pulleys and move together with the counterweight.

The cars may each be connected to the counterweight rope through the counterweight rope connection car pulley installed on each of the cars. In addition, in this case, the cars may each be operated by a drive pulley connected to a differential. A counterweight rope connection car pulley may be installed on each of the cars, and the cars may each be connected to the counterweight rope through a middle pulley and a counterweight connection car rope. In addition, in this case, the cars may each be operated by the drive pulley connected to the differential. In addition, in this case, the cars may each be operated by a two-pulley-built-in drive pulley. A drive pulley connection car pulley may be installed on each of the cars, and the cars may each be operated by the drive pulley and the drive pulley connection car rope. A drive pulley connection car pulley may be installed on each of the cars, and the cars may each be operated by the car side middle pulley, the counterweight side middle pulley, the middle rope, the drive pulley connection car rope, and the drive pulley and connected to the counterweight rope. The drive pulley connection car pulley may be installed on each of the cars, and the cars may each be operated by the two-pulley-built-in middle pulley, the drive pulley connection car rope, and the drive pulley and connected to the counterweight rope. The drive pulley connection car pulley may be installed on each of the cars, and the cars may each be operated by the counterweight side middle pulley, the drive pulley connection car rope, and the drive pulley and connected to the counterweight rope.

All the cars are connected to the counterweight through the counterweight rope and receive a force of the counterweight function.

In the present invention, in case that the counterweights, which are equal in number to the plurality of cars, are used, each of the plurality of cars and each of the counterweights may be connected to each other by using the counterweight rope. In addition, in this case, a drive pulley connection car pulley may be installed on each of the cars, and the cars may each be operated by a drive pulley and a drive pulley connection car rope. In addition, the cars may each be operated by a counterweight rope and a two-pulley-built-in drive pulley.

All the ropes connected to all the cars are connected to the cars through the pulleys installed at two opposite ends on imaginary radial straight lines disposed in different directions based on center vertical lines of the cars. All the imaginary radial straight lines are directed in different directions so as not to overlap one another.

### Effects of the Invention

The multi-car elevator according to the present invention is configured such that the plurality of cars may easily travel in the single elevator shaft. As necessary, the cars are additionally disposed and the counterweights, the ropes, the pulleys, and the like are installed while maximally utilizing the equipment in related art without extending the elevator shaft in related art, such that the elevator in related art may be comparatively simply changed to the multi-car elevator.

### BRIEF DESCRIPTION OF THE DRAWINGS

FIG. 1 is a view illustrating an example in which a counterweight 21 and a plurality of cars 1a, 1b, and 1c are connected in case that the plurality of cars 1a, 1b, and 1c is installed in a single elevator shaft. Two counterweight pulleys 23 are installed as movable pulleys on the counterweight 21. Two counterweight rope connection car pulleys 5a, 5b, and 5c are installed on each of the cars 1a, 1b, and 1c and connected to a counterweight rope 22. The counterweight rope 22 connects the counterweight 21 and all the cars 1a, 1b, and 1c, and two opposite ends of the counterweight rope 22 are fixed to the counterweight 21.

FIG. 2 is a view illustrating another example in which the counterweight 21 and the plurality of cars 1a, 1b, and 1c are connected in case that the plurality of cars 1a, 1b, and 1c is installed in the single elevator shaft. Three counterweight pulleys 23 are installed as movable pulleys on the counterweight 21.

The two opposite ends of the counterweight rope 22 are fixed to an external part such as a ceiling of the elevator shaft or a building. Unless otherwise specified, the term ‘fixing’ means a state of being fixed to a ceiling of an elevator shaft or a ceiling, a floor, a column, a wall, or the like of a building (hereinafter, referred to as ‘fixed’).

FIG. 3 is a view illustrating another example in which the counterweight 21 and the plurality of cars 1a, 1b, and 1c are connected in case that the plurality of cars 1a, 1b, and 1c is installed in the single elevator shaft. Three counterweight pulleys 23 are installed as movable pulleys on the counterweight 21. One end of the counterweight rope 22 is fixed, and the other end of the counterweight rope 22 is fixed to the counterweight 21. The counterweight rope 22 is attached to the counterweight 21 seven times.

FIG. 4 is a view illustrating another example in which the counterweight 21 and the plurality of cars 1a, 1b, and 1c are connected in case that the plurality of cars 1a, 1b, and 1c is installed in the single elevator shaft. Four counterweight pulleys 23 are installed as movable pulleys on the counterweight 21, and the two opposite ends of the counterweight rope 22 are connected to each other.

FIG. 5 is a view illustrating another example in which the counterweight 21 and the plurality of cars 1a, 1b, and 1c are connected in case that the plurality of cars 1a, 1b, and 1c is installed in the single elevator shaft. Five counterweight pulleys 23 are installed as movable pulleys on the counterweight 21. The counterweight rope 22 is attached to the counterweight 21 ten times, and the two opposite ends of the counterweight rope 22 are connected to each other.

FIG. 6 is a view illustrating another example in which the counterweight 21 and the plurality of cars 1a, 1b, and 1c are connected in case that the plurality of cars 1a, 1b, and 1c is installed in the single elevator shaft. Three counterweight pulleys 23 are installed as movable pulleys on the counterweight 21. Four car pulleys 5a are installed on one car 1a, and two car pulleys 5b and 5c are installed on each of the remaining cars 1b and 1c. The counterweight rope 22 connects the counterweight 21 and all the cars 1a, 1b, and 1c, and the two opposite ends of the counterweight rope 22 are fixed to the counterweight 21.

FIG. 7 is a view illustrating another example in which the counterweight 21 and the plurality of cars 1a, 1b, and 1c are connected in case that the plurality of cars 1a, 1b, and 1c is installed in the single elevator shaft. Three counterweight pulleys 23 are installed as movable pulleys on the counterweight 21. Two car pulleys 5a, 5b, and 5c are installed on each of the cars 1a, 1b, and 1c. The counterweight 21 and all the cars 1a, 1b, and 1c are divided into two sections, and the counterweight rope 22 is connected to the two sections one by one first and then connects the two sections.

FIG. 8 is a view illustrating another example in which the counterweight 21 and the plurality of cars 1a, 1b, and 1c are connected in case that the plurality of cars 1a, 1b, and 1c is installed in the single elevator shaft. Two counterweight pulleys 23 are installed as movable pulleys on the counterweight 21. The two opposite ends of the counterweight rope 22 are fixed to the counterweight 21. The counterweight rope 22 connects three three-pulley-built-in middle pulleys 18a, 18b, and 18c and the counterweight pulleys 23. Two fixing rods 12a are installed on a first car 1a, and two opposite ends of counterweight rope connection car ropes 3a, which connect the car 1a and the counterweight rope 22, are respectively fixed to the two fixing rods 12a. Car ropes 3a connected to fixed pulleys 19 are respectively connected to two pulleys of the middle pulley 18a. Two fixing rods 12b are installed on a second car 1b, and one end of each of two counterweight rope connection car ropes 3b, which connect the car 1b and the counterweight rope 22 are respectively fixed to the two fixing rods 12b. The two car ropes 3b with the other ends fixed are respectively connected to two pulleys of the middle pulley 18b. Two car pulleys 5c are installed on a third car 1c, and two opposite ends of counterweight rope connection car ropes 3c, which connect the car 1c and the counterweight rope 22, are respectively fixed. The car ropes 3c connected to the two car pulleys 5c are respectively connected to two pulleys of the middle pulley 18c.

FIG. 9 is a view illustrating another example in which the counterweight 21 and the plurality of cars 1a, 1b, and 1c are connected in case that the plurality of cars 1a, 1b, and 1c is installed in the single elevator shaft. The counterweight rope 22 connects two counterweight side middle pulleys 16b and 16c, a two-pulley-built-in middle pulley 17a, and counterweight pulleys 23. The two opposite ends of the car ropes 3a are fixed to the two fixing rods 12a of the first car 1a. One end of each of the two car ropes 3b is fixed to each of the two fixing rods 12b of the second car 1b, and the other end of each of the two car ropes 3b is fixed to the middle pulley 16b. The two opposite ends of the car ropes 3c of the third car 1c are fixed to the middle pulley 16c.

FIG. 10 illustrates an example in which two drive pulley connection car pulleys 4a are installed on the car 1a to connect a drive device to the car 1a illustrated in FIGS. 1 to 9, and a drive pulley connection car rope 2a is used to connect the car pulleys 4a to a one-pulley-built-in drive pulley 6a connected to a traction machine or the like.

FIG. 11 illustrates an example in which a part related to the counterweight rope 22 connected to the counterweight 21 illustrated in FIGS. 1 to 7 is integrated with the car pulleys 4a, the car rope 2a, and the drive pulley 6a illustrated in FIG. 10 in respect to the car 1a.

FIG. 12 illustrates an example in which a fixing rod 13a, a drive pulley connection car pulley 4a, and the drive pulley 6a are installed on the car 1a to connect the drive device to the car 1a illustrated in FIGS. 1 to 9, and the drive pulley connection car rope 2a is used to connect the car pulleys 4a and the drive pulley 6a.

FIG. 13 illustrates an example in which the part related to the counterweight rope 22 connected to the counterweight 21 is installed on the car 1a illustrated in FIGS. 1 to 7 and integrated with the fixing rod 13a, the car pulleys 4a, the car rope 2a, and the drive pulley 6a illustrated in FIG. 12.

FIG. 14 illustrates an example in which two drive pulleys 8a connected to either side of the differential are added to the part related to the counterweight rope 22 connected to the counterweight 21 in the car 1a illustrated in FIGS. 1 to 7, and the two drive pulleys 8a are connected to the counterweight rope 22 and connected to two opposite shafts of a differential 9a. Actually, a drive shaft 10a of the differential 9a may be connected to the traction machine or the like.

FIG. 15 illustrates another example in which two-pulley-built-in drive pulleys 7a, 7b, and 7c connected to the traction machine or the like capable of operating the cars 1a, 1b, and 1c, are connected to the car ropes 3a, 3b, and 3c in respect to the counterweight 21, the counterweight rope 22, the counterweight pulley 23, the middle pulleys 18a, 18b, and 18c, the car ropes 3a, 3b, and 3c, the fixing rods 12a and 12b, the car pulleys 5c, and the cars 1a, 1b, and 1c illustrated in FIG. 8.

FIG. 16 illustrates a state in which all the middle pulleys 18a, 18b, and 18c are provided at the upper ends.

FIG. 17 illustrates a state in which only one middle pulley 18a is provided at the lower end.

FIG. 18 illustrates a state in which only two middle pulleys 18a and 18b are provided at the lower ends.

FIG. 19 illustrates a state in which all the middle pulleys 18a, 18b, and 18c are provided at the lower ends. Distances between the middle pulleys 18a, 18b, and 18c each correspond to ½ of a traveling distance of each of the cars 1a, 1b, and 1c.

FIG. 20 illustrates another example in which one-pulley-built-in drive pulleys 6a, 6b, and 6c, the counterweight 21, and the cars 1a, 1b, and 1c are connected in respect to the plurality of cars 1a, 1b, and 1c installed in the single elevator shaft. Car ropes 2a, 2b, and 2c, car pulleys 4a, 4b, and 4c, the drive pulleys 6a, 6b, and 6c, car side middle pulleys 15a, 15b, and 15c, middle ropes 14a, 14b, and 14c, counterweight side middle pulleys 16a, 16b, and 16c, the counterweight 21, the counterweight pulley 23, and the counterweight rope 22 are used.

FIG. 21 is a modified example of FIG. 20 and illustrates an example in which all the middle ropes 14a, 14b, and 14c illustrated in FIG. 20 are excluded, the car side middle pulleys 15a, 15b, and 15c and the counterweight side middle pulleys 16a, 16b, and 16c are integrated into two-pulley-built-in middle pulleys 17a, 17b, and 17c, and the counterweight rope 22 is further extended.

FIG. 22 is a modified example of FIG. 21 and illustrates an example in which the counterweight rope 22 is shortened, and instead, the car ropes 2a, 2b, and 2c are elongated.

FIG. 23 is a modified example of FIG. 21 and illustrates an example in which the counterweight 21 is positioned at a position below the middle pulleys 17a, 17b, and 17c, four counterweight pulleys 23 are installed as movable pulleys on the counterweight 21, and the two opposite ends of the counterweight rope 22 are fixed.

FIG. 24 illustrates a shape in which all the middle pulleys 17a, 17b, and 17c illustrated in FIG. 23 are provided at the highest positions.

FIG. 25 illustrates a shape in which some middle pulleys 17b and 17c are provided at the highest position and one middle pulley 17a is provided at the lowest position among the middle pulleys 17a, 17b, and 17c illustrated in FIG. 23.

FIG. 26 illustrates a shape in which one middle pulley 17c is provided at the highest position and the other middle pulleys 17a and 17b are positioned at the lowest position among the middle pulleys 17a, 17b, and 17c illustrated in FIG. 23.

FIG. 27 illustrates a shape in which all the middle pulleys 17a, 17b, and 17c illustrated in FIG. 23 are provided at the lowest positions.

FIG. 28 illustrates positions of the middle pulleys 17a, 17b, and 17c and the counterweight 21 in case that the four counterweight pulleys 23 installed on the counterweight 21 illustrated in FIGS. 23 to 27 are changed to two counterweight pulleys 23, the counterweight rope 22 is connected, and the two opposite ends of the counterweight rope 22 are fixed to the counterweight 21.

FIG. 29 illustrates a case in which the two counterweight pulleys 23 illustrated in FIG. 28 are used in an intact manner, and the two opposite ends of the counterweight rope 22 are fixed without being fixed to the counterweight 21.

FIG. 30 illustrates a case in which the four counterweight pulleys 23 illustrated in FIG. 23 are changed to five counterweight pulleys 23, and the counterweight rope 22 is connected.

FIG. 31 illustrates another example in which the one-pulley-built-in drive pulleys 6a, 6b, and 6c, the counterweight 21, and the cars 1a, 1b, and 1c are connected in respect to the plurality of cars 1a, 1b, and 1c installed in the single elevator shaft. The car ropes 2a, 2b, and 2c, the car pulleys 4a, 4b, and 4c, the drive pulleys 6a, 6b, and 6c, the counterweight 21, the counterweight pulley 23, the counterweight rope 22, and the counterweight side middle pulleys 16a, 16b, and 16c are used.

FIG. 32 illustrates an example in which all the counterweight side middle pulleys 16a, 16b, and 16c are provided at the highest position, such that the counterweight 21 is also provided at the highest position.

FIG. 33 illustrates an example in which one middle pulley 16a is provided at the lowest position.

FIG. 34 illustrates an example in which the two middle pulleys 16a and 16b are provided at the lowest positions.

FIG. 35 illustrates an example in which all the middle pulleys 16a, 16b, and 16c are provided at the lowest position, such that the counterweight 21 is also provided at the lowest position.

FIG. 36 illustrates an example in which car connection counterweights 21a, 21b, and 21c, which are equal in number to the plurality of cars 1a, 1b, and 1c installed in the single elevator shaft, are used. Counterweight fixing rods 20a, 20b, and 20c are installed two by two on each of the car connection counterweights 21a, 21b, and 21c, counterweight connection fixing rods 11a, 11b, and 11c are installed two by two on each of the cars 1a, 1b, and 1c, and the counterweight fixing rods 20a, 20b, and 20c and the counterweight connection fixing rods 11a, 11b, and 11c are connected, one by one, to the car connection counterweight ropes 22a, 22b, and 22c.

### DETAILED DESCRIPTION OF THE INVENTION

The specific contents of the present invention will be described in detail with reference to the embodiment of the present invention illustrated in the accompanying drawings. However, the contents of the present invention are not limited to the contents illustrated in the drawings.

In case that a plurality of cars is configured to be operable in a single elevator shaft, various policies may be used to assign traveling sections of the cars or determine traveling methods. For example, assuming that in a 30-story building, a first car may move between a first floor and a twenty-eighth floor, a second car may move between a second floor and a twenty-ninth floor, and a third car may move between a third floor and a thirtieth floor, all the three cars may be connected and attached to each other and operated together like a train, the three cars may be started one by one at time intervals. Alternatively, the three cars may travel in separated sections, such that the first car may travel from the first floor to the tenth floor, the second car may travel from the tenth floor to the twentieth 20, and the third car may travel from the twentieth floor to the thirtieth floor. In case that the cars travel like a train, it is necessary to determine whether the next floor on which the first car may stop after the first car starts from the first floor is the second floor or the fourth floor. In case that the cars start one by one at a time interval, in an upward movement mode, the third car may start from the third floor, the second car may start from the second floor at a predetermined time interval, and the first car may start from the first floor at a predetermined time. In a downward movement mode, the first car may start from the twenty-eighth floor, the second car may start from the twenty-ninth floor, and the third car may start from the thirtieth floor at predetermined time intervals. In general, the car traveling ahead picks up the waiting riders first. However, in case that the number of riders traveling in either the upward or downward direction is significantly larger than the number of riders traveling in the opposite direction, such as during rush hour, the last car traveling in the direction with fewer riders may pick up the waiting riders first in order to pick up the most riders in a short amount of time. In any case, the car traveling behind should not collide with the car traveling ahead, but should wait if necessary, and should not stop because there is no one waiting ahead. In case that the car behind has occupants, the car traveling ahead may need to move out of the way. In case that the cars travel in the separated sections such that the first car travels from the first floor to the tenth floor, the second car travels from the tenth floor to the twentieth floor, and the third car travels from the twentieth floor to the thirtieth floor, the tenth floor and the twentieth floor may be transfer floors where the two cars operate. In case that one car is stopped on the transfer floor, a next car, which is intended to go to the transfer floor, may travel after waiting on a previous floor until the stopped car leaves. In case that the stopped car is waiting on the transfer floor with no occupant, the waiting car may be moved to the next floor and wait on the next floor, and the next waiting car may be stopped on the transfer floor. The transfer floor may be often changed as necessary, and the change of the transfer floor may be mainly set by software programs. The description does not mean that the number of cars is limited to three, the number of floors of the building is limited to thirty, or the basements are excluded. There is no restriction on the number of floors or basements. The present invention does not address software programs. The present invention addresses a configuration in which a plurality of cars travels in a single elevator shaft.

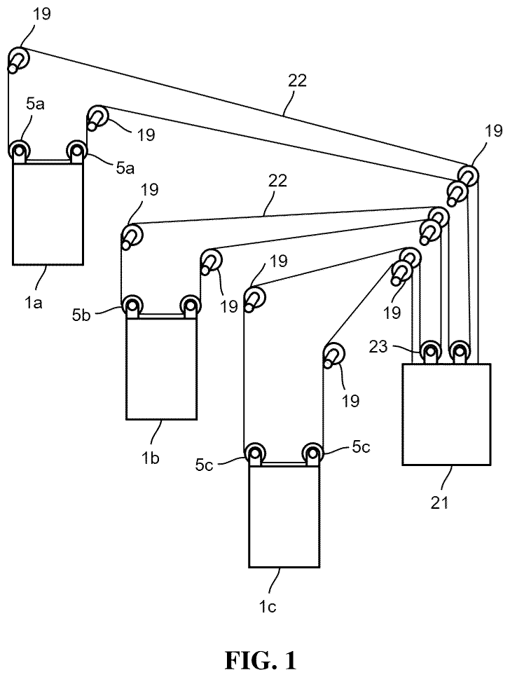

FIG. 1 is a view illustrating an example in which the counterweight 21 and the plurality of cars 1a, 1b, and 1c are connected in case that the plurality of cars 1a, 1b, and 1c is installed in the single elevator shaft. The two counterweight pulleys 23 are installed as movable pulleys on the counterweight 21. The two counterweight rope connection car pulleys 5a, 5b, and 5c are installed on each of the cars 1a, 1b, and 1c and connected to the counterweight rope 22. The counterweight rope 22 connects the counterweight 21 and all the cars 1a, 1b, and 1c, and the two opposite ends of the counterweight rope 22 are fixed to the counterweight 21. The fixed pulleys 19 are installed so that middle portions of the counterweight rope 22 do not come into contact with each other. The positions of the cars 1a, 1b, and 1c illustrated in FIG. 1 are spread to allow a connection relationship of the counterweight rope 22 to be easily recognized and assist in understanding the present invention. Actually, the cars 1a, 1b, and 1c are disposed in the single elevator shaft. The positions of the cars 1a, 1b, and 1c may be adjusted by adjusting the positions of the fixed pulleys 19.

The number of cars 1a, 1b, and 1c and the type of counterweight rope 22 are not limited.

A weight of a counterweight function applied to each of the cars 1a, 1b, and 1c by one counterweight 21 will be described with reference to FIG. 1. The weight of the counterweight 21 is dispersed to the counterweight rope 22 attached six times (also referred to as a ‘section’ and the term ‘attached’ will be disclosed). Therefore, a weight of ⅙ of the weight of the counterweight 21 is applied to the counterweight rope 22. The counterweight rope 22 may be attached to each of the cars 1a, 1b, and 1c two times, such that 2/6 of the weight of the counterweight 21 is applied to all the cars 1a, 1b, and 1c. Therefore, the fractions of the weight of the counterweight required for the cars 1a, 1b, and 1c may be equal to one another, and an appropriate weight of the counterweight 21 is equal to a sum of the fractions of the weight of the counterweight required for the cars 1a, 1b, and 1c. However, as described below in the following examples, the weight may vary depending on a method of connecting the counterweight rope 22 and is not limited thereto.

A movement distance of the counterweight 21 will be described with reference to FIG. 1. When one of the cars 1a, 1b, and 1c moves 1 m, a length of the counterweight rope 22, which holds the cars 1a, 1b, and 1c, is changed by 2 m. Because the counterweight rope 22 is attached to the counterweight 21 six times, the change in the length of the counterweight rope 22 by 2 m moves the counterweight 21 by 2/6 m. Therefore, with reference to FIG. 1, the counterweight 21 moves a ⅓ distance in a direction opposite to the movement distance of each of the cars 1a, 1b, and 1c. When all the cars 1a, 1b, and 1c move 1 m in the same direction, the counterweight 21 moves 1 m in the opposite direction.

In FIG. 1, the two opposite ends of the counterweight rope 22 fixed to the counterweight 21 may be connected to each other without being fixed to the counterweight 21. One counterweight pulley 23 is further installed as a movable pulley on the counterweight 21, such that the three counterweight pulleys 23 are installed on the counterweight 21, and the two opposite ends of the counterweight rope 22 are connected to each other by the additional counterweight pulley 23. Even in this case, the counterweight rope 22 is attached to the counterweight 21 six times.

In FIG. 1, the two opposite ends of the counterweight rope 22 fixed to the counterweight 21 may be fixed to a bottom or the like without being fixed to the counterweight 21. Therefore, the counterweight rope 22 is attached to the counterweight 21 four times, a weight of ¼ of the weight of the counterweight 21 is applied to the counterweight rope 22, and 2/4 of the weight of the counterweight 21 is applied to all the cars 1a, 1b, and 1c. When one of the cars 1a, 1b, and 1c moves 1 m, the length of the counterweight rope 22, which holds the cars 1a, 1b, and 1c, is changed by 2 m. Because the counterweight rope 22 is attached to the counterweight 21 four times, the change in the length of the counterweight rope 22 by 2 m moves the counterweight 21 by 2/4 m. When all the cars 1a, 1b, and 1c move 1 m in the same direction, the counterweight 21 moves 6/4 m in the opposite direction.

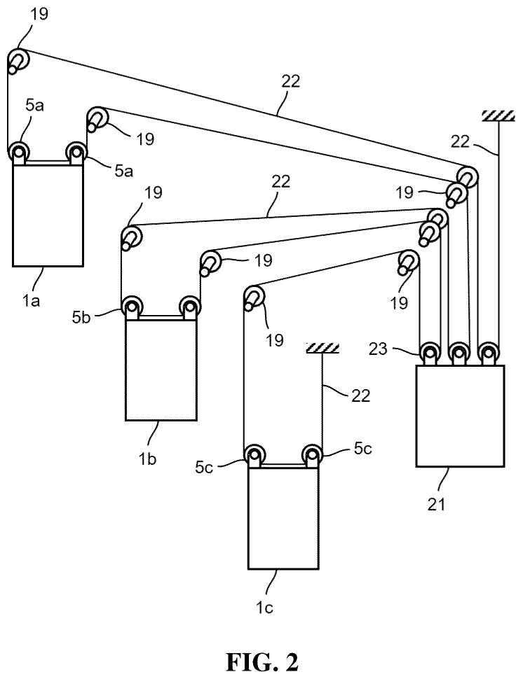

FIG. 2 is a view illustrating another example in which the counterweight 21 and the plurality of cars 1a, 1b, and 1c are connected in case that the plurality of cars 1a, 1b, and 1c is installed in the single elevator shaft. This example differs from the example in FIG. 1 in that the three counterweight pulleys 23 are installed as movable pulleys on the counterweight 21, the two opposite ends of the counterweight rope 22 are fixed to a ceiling of the elevator shaft, a building, or the like without being fixed to the counterweight 21. The counterweight rope 22 is attached to the counterweight 21 six times.

In FIG. 2, any one of the three counterweight pulleys 23 installed on the counterweight 21 may be excluded, and the two counterweight pulleys 23 may be installed on the counterweight 21. In this case, the counterweight rope 22 is attached to the counterweight 21 four times, and a weight of ¼ of the weight of the counterweight 21 is applied to the counterweight rope 22. The counterweight rope 22 may be attached to each of the cars 1a, 1b, and 1c two times, such that 2/4 of the weight of the counterweight 21 is applied to all the cars 1a, 1b, and 1c. When one of the cars 1a, 1b, and 1c moves 1 m, the length of the counterweight rope 22, which holds the cars 1a, 1b, and 1c, is changed by 2 m. Because the counterweight rope 22 is attached to the counterweight 21 four times, the change in the length of the counterweight rope 22 by 2 m moves the counterweight 21 by 2/4 m. When all the cars 1a, 1b, and 1c move 1 m in the same direction, the counterweight 21 moves 6/4 m in the opposite direction. Because the counterweight 21 moves the distance longer than the distance that all the cars 1a, 1b, and 1c move in the same direction, the use of the counterweight 21 is restricted. Therefore, this shape may be used only in a case in which the cars 1a, 1b, and 1c travel in the separated sections, and a traveling section of each of the cars 1a, 1b, and 1c is shorter than a length of the elevator shaft.

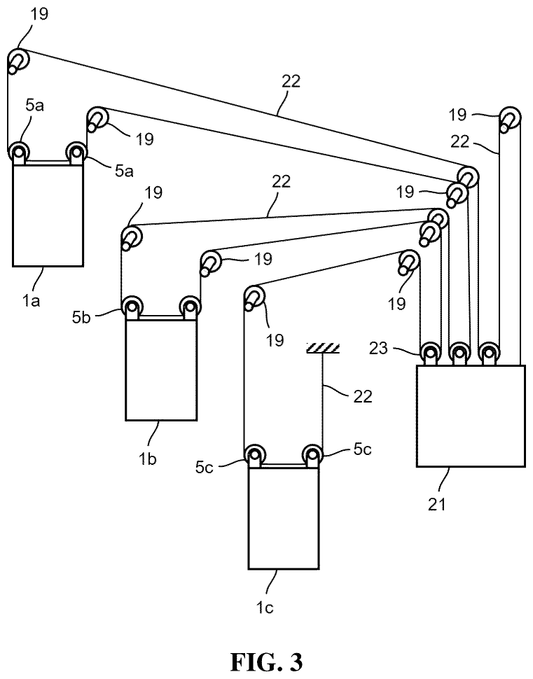

FIG. 3 is a view illustrating another example in which the counterweight 21 and the plurality of cars 1a, 1b, and 1c are connected in case that the plurality of cars 1a, 1b, and 1c is installed in the single elevator shaft. This example differs from the example in FIG. 2 in that one end of the counterweight rope 22 is fixed, the other end of the counterweight rope 22 is fixed to the counterweight 21, and the counterweight rope 22 is attached to the counterweight 21 seven times. The fixed pulleys 19 may be further used.

The weight of the counterweight 21 in FIG. 3 is dispersed to the counterweight rope 22 attached seven times. Therefore, a weight of 1/7 of the weight of the counterweight 21 is applied to the counterweight rope 22. The counterweight rope 22 may be attached to each of the cars 1a, 1b, and 1c two times, such that 2/7 of the weight of the counterweight 21 is applied to all the cars 1a, 1b, and 1c. In addition, when one of the cars 1a, 1b, and 1c moves 1 m, the length of the counterweight rope 22, which holds the cars 1a, 1b, and 1c, is changed by 2 m. Because the counterweight rope 22 is attached to the counterweight 21 seven times, the change in the length of the counterweight rope 22 by 2 m moves the counterweight 21 by 2/7 m.

In FIG. 3, one counterweight pulley 23 may be further installed as a movable pulley on the counterweight 21, such that the four counterweight pulleys 23 may be installed on the counterweight 21. One end of the counterweight rope 22 fixed to the counterweight 21 is separated, connected to the additionally installed counterweight pulley 23, and then fixed. In this case, the counterweight rope 22 is attached to the counterweight 21 eight times. Therefore, a weight of ⅛ of the weight of the counterweight 21 is applied to the counterweight rope 22, and 2/8 of the weight of the counterweight 21 is applied to all the cars 1a, 1b, and 1c. When one of the cars 1a, 1b, and 1c moves 1 m, the counterweight 21 moves 2/8 m. The weight of the counterweight function is 2/8 of the weight of the counterweight 21. The movement distance of the counterweight 21 moves a 2/8 distance in the direction opposite to the movement distance of each of the cars 1a, 1b, and 1c.

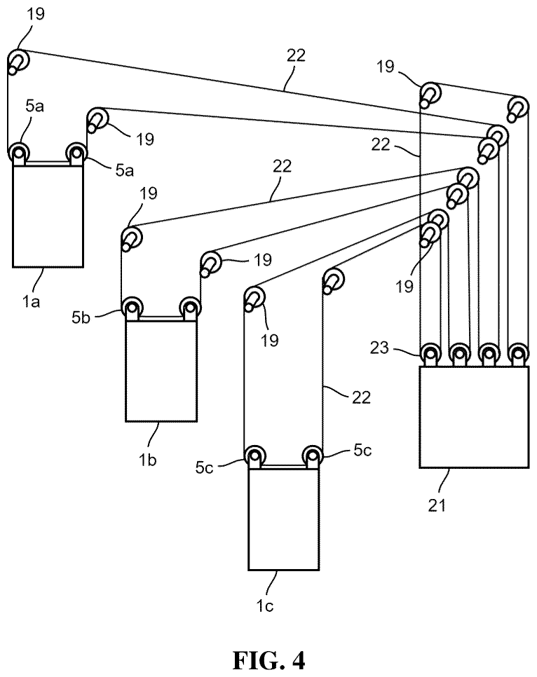

FIG. 4 is a view illustrating another example in which the counterweight 21 and the plurality of cars 1a, 1b, and 1c are connected in case that the plurality of cars 1a, 1b, and 1c is installed in the single elevator shaft. This example differs from the example in FIG. 1 in that the four counterweight pulleys 23 are installed as movable pulleys on the counterweight 21, the two opposite ends of the counterweight rope 22 are connected to each other, and the counterweight rope 22 is attached to the counterweight 21 eight times. The fixed pulleys 19 may be further used. Even in this case, the weight of the counterweight function is 2/8 of the weight of the counterweight 21. The movement distance of the counterweight 21 moves a 2/8 distance in the direction opposite to the movement distance of each of the cars 1a, 1b, and 1c.

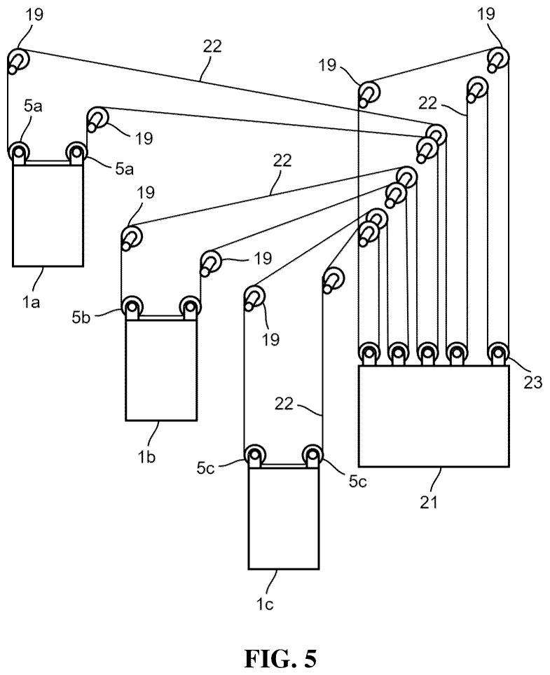

FIG. 5 is a view illustrating another example in which the counterweight 21 and the plurality of cars 1a, 1b, and 1c are connected in case that the plurality of cars 1a, 1b, and 1c is installed in the single elevator shaft. This example differs from the example in FIG. 4 in that the five counterweight pulleys 23 are installed as movable pulleys on the counterweight 21, and the counterweight rope 22 is attached to the counterweight 21 ten times. The fixed pulleys 19 may be further used. In this case, the weight of the counterweight function is 2/10 of the weight of the counterweight 21. The movement distance of the counterweight 21 moves a 2/10 distance in the direction opposite to the movement distance of each of the cars 1a, 1b, and 1c.

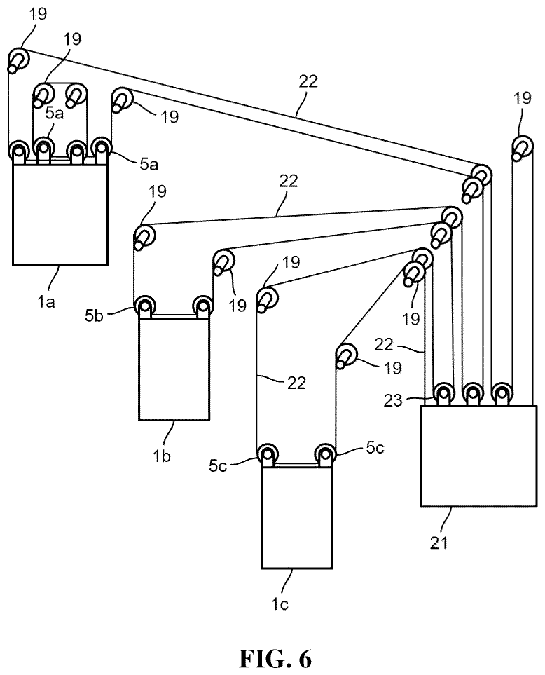

FIG. 6 is a view illustrating another example in which the counterweight 21 and the plurality of cars 1a, 1b, and 1c are connected in case that the plurality of cars 1a, 1b, and 1c is installed in the single elevator shaft. This example differs from the example in FIG. 1 in that the three counterweight pulleys 23 are installed as movable pulleys on the counterweight 21, the four car pulleys 5a are installed on one car 1a, the counterweight rope 22 is attached to the counterweight 21 eight times, the counterweight rope 22 is attached to one car 1a four times, and the counterweight rope 22 is attached to the remaining cars 1b and 1c two times. The fixed pulleys 19 may be further used. Therefore, a weight of ⅛ of the weight of the counterweight 21 is applied to the counterweight rope 22, 4/8 of the weight of the counterweight 21 is applied to one car 1a, and 2/8 of the weight of the counterweight 21 is applied to the other cars 1b and 1c. When one car 1a moves 1 m, the counterweight 21 moves 4/8 m. When the other cars 1b and 1c move 1 m, the counterweight 21 moves 2/8 m.

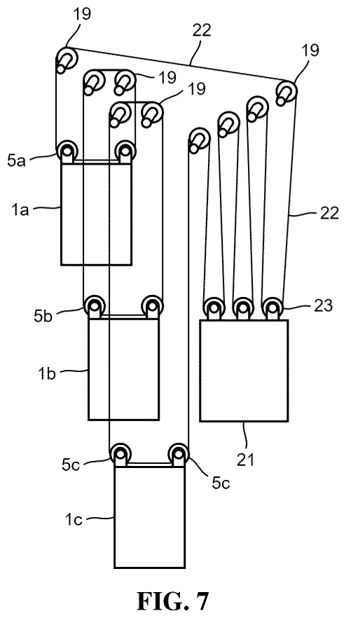

FIG. 7 is a view illustrating another example in which the counterweight 21 and the plurality of cars 1a, 1b, and 1c are connected in case that the plurality of cars 1a, 1b, and 1c is installed in the single elevator shaft. This example differs from the example in FIG. 1 in that the three counterweight pulleys 23 are installed as movable pulleys on the counterweight 21, the two opposite ends of the counterweight rope 22 are connected to each other, and the counterweight rope 22 connects the cars 1a, 1b, and 1c and the counterweight 21 only two times. The counterweight rope 22 is attached to the counterweight 21 six times. In this case, the weight of the counterweight function is 2/6 of the weight of the counterweight 21. The movement distance of the counterweight 21 moves a 2/6 distance in the direction opposite to the movement distance of each of the cars 1a, 1b, and 1c.

In FIG. 7, the number of counterweight pulleys 23 may be easily changed. In case that the number of counterweight pulleys 23 increases, the weight of the counterweight function applied to the cars 1a, 1b, and 1c by the weight of the counterweight 21 decreases, and the movement distance of the counterweight 21 decreases with respect to the movement distance of the cars 1a, 1b, and 1c. In case that the number of counterweight pulleys 23 decreases, the weight of the counterweight function applied to the cars 1a, 1b, and 1c by the weight of the counterweight 21 increases, and the movement distance of the counterweight 21 increases with respect to the movement distance of the cars 1a, 1b, and 1c. For example, when the number of counterweight pulleys 23 is 1, the weight of the counterweight function applied to the cars 1a, 1b, and 1c by the weight of the counterweight 21 is equal to the weight of the counterweight 21, and the movement distance of the counterweight 21 is equal to the movement distance of the cars 1a, 1b, and 1c. When all the cars 1a, 1b, and 1c move 1 m in the same direction, the counterweight 21 moves 3 m in the opposite direction. Because the counterweight 21 moves the distance longer than the distance that all the cars 1a, 1b, and 1c move in the same direction, the use of the counterweight 21 is restricted. Therefore, this shape may be used only in a case in which the cars 1a, 1b, and 1c travel in the separated sections, and a traveling section of each of the cars 1a, 1b, and 1c is shorter than a length of the elevator shaft.

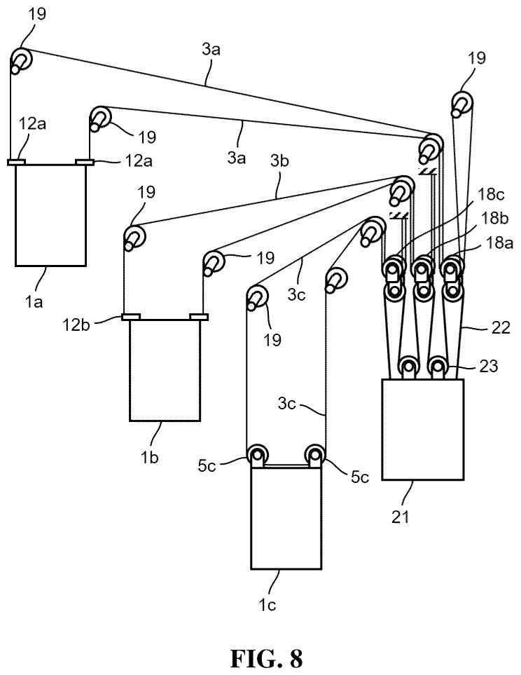

In FIGS. 4 to 6, the car pulleys 5a, 5b, and 5c are installed on all the cars 1a, 1b, and 1c. However, the present invention is not limited thereto. Two fixing rods 12a, 12b, and 12c illustrated in FIG. 8 may be installed on any one of the cars 1a, 1b, and 1c, instead of the two car pulleys 5a, 5b, and 5c connected to the counterweight rope 22, and fixed to the fixing rods 12a, 12b, and 12c installed at the two opposite ends of the counterweight rope 22.

In this case, the fixing rods 12a, 12b, and 12c are objects protruding outward from edges of the cars 1a, 1b, and 1c and configured to support the cars 1a, 1b, and 1c. The fixing rods 12a, 12b, and 12c may be attached and installed in the form of a rod or the like or protrude from the cars 1a, 1b, and 1c. The same may also apply to the car connection counterweights 21a, 21b, and 21c. Hereinafter, the object or the protruding portion of each of the cars 1a, 1b, and 1c or each of the car connection counterweights 21a, 21b, and 21c will be referred to as a ‘fixing rod’.

Even in FIG. 7, the method of connecting the counterweight rope 22 may be variously changed. For example, in FIG. 7, the two opposite ends of the counterweight rope 22 may be fixed by cutting the middle portion connected to the fixed pulley 19 provided above the car 1a to which the counterweight rope 22 is connected from the fixed pulley 19 provided above the counterweight 21.

In another example, one counterweight pulley 23 may be separated from the counterweight 21, and the separated counterweight pulley 23 may be fixed to the bottom. Further, the counterweight pulley 23 fixed to the bottom may be removed, and the counterweight rope 22 may be pulled and fixed to the bottom. In this case, the counterweight rope 22 is attached to the counterweight 21 four times. In this case, the weight of the counterweight function is 2/4 of the weight of the counterweight 21. The movement distance of the counterweight 21 moves a 2/4 distance in the direction opposite to the movement distance of each of the cars 1a, 1b, and 1c. Even in this case, when all the cars 1a, 1b, and 1c move 1 m in the same direction, the counterweight 21 moves 6/4 m in the opposite direction, such that the movement distance of the counterweight 21 is longer than the movement distance that all the car 1b, 1b, and 1c simultaneously move in the same direction.

From the above-mentioned description, it is sufficient to know that the connection of the counterweight rope 22 may be variously changed, and an appropriate connection method may be used, as necessary.

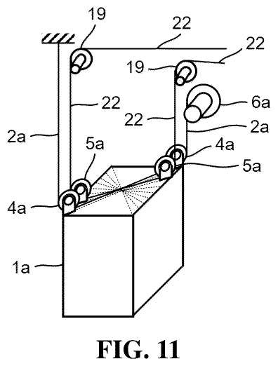

FIGS. 1 to 7 illustrate the examples in which the counterweight 21 and the cars 1a, 1b, and 1c are connected. Actual positions of the cars 1a, 1b, and 1c are disposed in the single elevator shaft so as not to collide with one another upward and downward in the elevator shaft. The method of preventing the middle portions of the counterweight rope 22 from coming into contact with each other will be described together with the following description described with reference to FIG. 11.

FIG. 8 is a view illustrating another example in which the counterweight 21 and the plurality of cars 1a, 1b, and 1c are connected in case that the plurality of cars 1a, 1b, and 1c is installed in the single elevator shaft. The two counterweight pulleys 23 are installed as movable pulleys on the counterweight 21. The two opposite ends of the counterweight rope 22 are fixed to the counterweight 21. The counterweight rope 22 connects the three three-pulley-built-in middle pulleys 18a, 18b, and 18c and the counterweight pulleys 23. The two fixing rods 12a are installed on the first car 1a, and the two opposite ends of the counterweight rope connection car ropes 3a, which connect the car 1a and the counterweight rope 22, are respectively fixed to the two fixing rods 12a. The car ropes 3a connected to the fixed pulleys 19 are respectively connected to the two pulleys of the middle pulley 18a. The two fixing rods 12b are installed on the second car 1b, and one end of each of the two counterweight rope connection car ropes 3b, which connect the car 1b and the counterweight rope 22 are respectively fixed to the two fixing rods 12b. The two car ropes 3b with the other ends fixed are respectively connected to the two pulleys of the middle pulley 18b. The two car pulleys 5c are installed on the third car 1c, and the two opposite ends of the counterweight rope connection car ropes 3c, which connect the car 1c and the counterweight rope 22, are respectively fixed. The car ropes 3c connected to the two car pulleys 5c are respectively connected to the two pulleys of the middle pulley 18c.

The methods of connecting the car ropes 3a, 3b, and 3c connected to the cars 1a, 1b, and 1c are different from one another. This is intended to introduce different methods with different advantages and disadvantages and is not intended to limit the present invention. There is no restriction.

The fixed pulleys 19 are installed so that the middle portions of the counterweight rope 22 and the middle portions of the car ropes 3a, 3b, and 3c are not in contact with one another. The positions of the cars 1a, 1b, and 1c illustrated in FIG. 8 are spread to allow a connection relationship of the car ropes 3a, 3b, and 3c to be easily recognized and assist in understanding the present invention. Actually, the cars 1a, 1b, and 1c are disposed in the single elevator shaft. The positions of the cars 1a, 1b, and 1c may be adjusted by adjusting the positions of the fixed pulleys 19.

The number of cars 1a, 1b, and 1c, the type of counterweight rope 22, and the types of car ropes 3a, 3b, and 3c are not limited.

The weight of the counterweight function applied to each of the cars 1a, 1b, and 1c by one counterweight 21 will be described with reference to FIG. 8. The weight of the counterweight 21 is dispersed to the counterweight rope 22 attached six times. Therefore, a weight of ⅙ of the weight of the counterweight 21 is applied to the counterweight rope 22. The counterweight rope 22 is attached to each of the middle pulleys 18a, 18b, and 18c two times, and the car ropes 3a, 3b, and 3c are each attached to each of the middle pulleys 18a, 18b, and 18c four times. Therefore, a weight of 2/6 of the weight of the counterweight 21 is applied to the middle pulleys 18a, 18b, and 18c. The car ropes 3a, 3b, and 3c are each attached to each of the cars 1a, 1b, and 1c two times, such that ⅙ of the weight of the counterweight 21 is applied to each of the cars 1a, 1b, and 1c. Therefore, the fractions of the weight of the counterweight required for the cars 1a, 1b, and 1c may be equal to one another, and an appropriate weight of the counterweight 21 is equal to twice a sum of the fractions of the weight of the counterweight required for the cars 1a, 1b, and 1c. However, the present invention is not limited thereto.

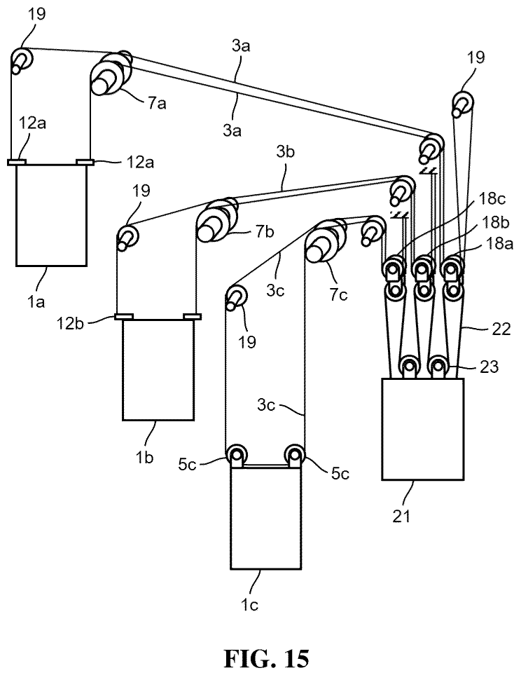

The movement distance of the counterweight 21 will be described with reference to FIG. 8. When one of the cars 1a, 1b, and 1c moves 1 m, the middle pulleys 18a, 18b, and 18c, which hold the cars 1a, 1b, and 1c, move ½ m in the opposite direction. Then, the length of the connected counterweight rope 22 is changed by 1 m. Because the counterweight rope 22 is attached to the counterweight 21 six times, the change in the length of the counterweight rope 22 by 1 m moves the counterweight 21 by ⅙ m. Therefore, with reference to FIG. 8, the counterweight 21 moves a ⅙ distance in the direction opposite to the movement distance of each of the cars 1a, 1b, and 1c. When all the cars 1a, 1b, and 1c move 1 m in the same direction, the counterweight 21 moves 3/6 m in the opposite direction. However, in FIG. 8, in case that the cars 1a, 1b, and 1c move 1 m, the middle pulleys 18a, 18b, and 18c also move ½ m together with the counterweight 21. Therefore, the length of the elevator shaft is divided and used for the middle pulleys 18a, 18b, and 18c and the counterweight 21, and the traveling distances of the cars 1a, 1b, and 1c may also be restricted. This configuration will be analyzed in detail with reference to FIGS. 15 to 19.

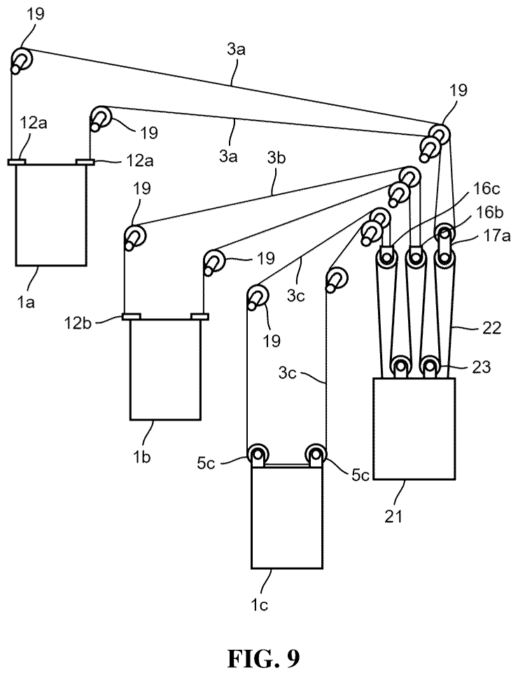

FIG. 9 is a view illustrating another example in which the counterweight 21 and the plurality of cars 1a, 1b, and 1c are connected in case that the plurality of cars 1a, 1b, and 1c is installed in the single elevator shaft. The two counterweight pulleys 23 are installed as movable pulleys on the counterweight 21. The two opposite ends of the counterweight rope 22 are fixed to the counterweight 21. The counterweight rope 22 connects the two counterweight side middle pulleys 16b and 16c, the two-pulley-built-in middle pulley 17a, and the counterweight pulley 23. The two fixing rods 12a are installed on the first car 1a, and the two opposite ends of the car rope 3a are respectively fixed to the two fixing rods 12a. The car rope 3a is connected to the middle pulley 17a, and the two fixing rods 12b are installed on the second car 1b. One end of each of the two car ropes 3b is fixed to each of the two fixing rods 12b, and the other end of each of the two car ropes 3b is fixed to the middle pulley 16b. The two car pulleys 5c are installed on the third car 1c, and the two opposite ends of the car rope 3c connected to the two car pulleys 5c are fixed to the middle pulley 16c.

The fixed pulleys 19 are installed so that the middle portions of the counterweight rope 22 and the middle portions of the car ropes 3a, 3b, and 3c are not in contact with one another. The positions of the cars 1a, 1b, and 1c illustrated in FIG. 9 are spread to allow a connection relationship of the car ropes 3a, 3b, and 3c to be easily recognized and assist in understanding the present invention. Actually, the cars 1a, 1b, and 1c are disposed in the single elevator shaft. The positions of the cars 1a, 1b, and 1c may be adjusted by adjusting the positions of the fixed pulleys 19.

The number of cars 1a, 1b, and 1c, the type of counterweight rope 22, and the types of car ropes 3a, 3b, and 3c are not limited.

The weight of the counterweight function applied to each of the cars 1a, 1b, and 1c by one counterweight 21 will be described with reference to FIG. 9. The weight of the counterweight 21 is dispersed to the counterweight rope 22 attached six times. Therefore, a weight of ⅙ of the weight of the counterweight 21 is applied to the counterweight rope 22. The counterweight rope 22 is attached to each of the middle pulleys 16b, 16c, and 17a two times, and the car ropes 3a, 3b, and 3c are each also attached to each of the middle pulleys 16b, 16c, and 17a two times. Therefore, a weight of 2/6 of the weight of the counterweight 21 is applied to each of the middle pulleys 16b, 16c, and 17a. The car ropes 3a, 3b, and 3c are each attached to each of the cars 1a, 1b, and 1c two times, such that 2/6 of the weight of the counterweight 21 is also applied to each of the cars 1a, 1b, and 1c. Therefore, the fractions of the weight of the counterweight required for the cars 1a, 1b, and 1c may be equal to one another, and an appropriate weight of the counterweight 21 is equal to a sum of the fractions of the weight of the counterweight required for the cars 1a, 1b, and 1c. However, the present invention is not limited thereto.

The movement distance of the counterweight 21 will be described with reference to FIG. 9. When one of the cars 1a, 1b, and 1c moves 1 m, the middle pulleys 16b, 16c, and 17a, which hold the cars 1a, 1b, and 1c, move 1 m in the opposite direction. Then, the length of the connected counterweight rope 22 is changed by 2 m. Because the counterweight rope 22 is attached to the counterweight 21 six times, the change in the length of the counterweight rope 22 by 2 m moves the counterweight 21 by 2/6 m. Therefore, with reference to FIG. 9, the counterweight 21 moves a ⅓ distance in the direction opposite to the movement distance of each of the cars 1a, 1b, and 1c. When all the cars 1a, 1b, and 1c move 1 m in the same direction, the counterweight 21 moves 1 m in the opposite direction. However, in FIG. 9, in case that the cars 1a, 1b, and 1c move 1 m, the middle pulleys 16b, 16c, and 17a also move 1 m together with the counterweight 21. Therefore, the length of the elevator shaft is divided and used for the middle pulleys 16b, 16c, and 17a and the counterweight 21, and the traveling distances of the cars 1a, 1b, and 1c may also be further restricted in comparison with the example illustrated in FIG. 8.

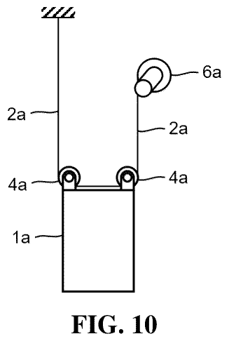

FIG. 10 illustrates an example of a drive device capable of being used for the cars 1a, 1b, and 1c illustrated in FIGS. 1 to 9. It can be seen that the two drive pulley connection car pulleys 4a connected to the one-pulley-built-in drive pulley 6a connected to the traction machine or the like to operate one car 1a, are installed on the car 1a, and the drive pulley connection car rope 2a, which connects the car pulley 4a and the drive pulley 6a, is used to connect the car pulley 4a and the drive pulley 6a. One end of the car rope 2a is fixed. With the properties of the drive pulley 6a, the other end of the car rope 2a may be wound around the drive pulley 6a, extended toward one side past the drive pulley 6a, or wound around a separate wheel such as a rope winding drum.

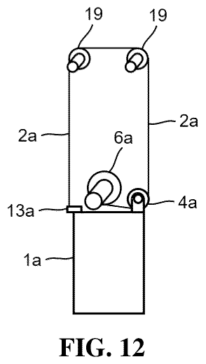

In FIG. 10, the drive pulley 6a may be changed to the two-pulley-built-in drive pulley 7a connected to the traction machine or the like illustrated in FIG. 15, and the two opposite ends of the car rope 2a may be respectively connected to the two pulleys of the drive pulley 7a. The fixed pulleys 19 may be further used. In addition, the two drive pulley connection car pulleys 4a may be changed to the fixing rods 13a illustrated in FIG. 12, and the two opposite ends of the car rope 2a may be respectively fixed to the two fixing rods 13a.

The fixed pulley 19, the drive pulley 6a, the drive pulley 7a, the car pulley 4a, and the fixing rod 13a are installed so that the middle portions of the car rope 2a are not in contact with each other.

From the above-mentioned description, it is sufficient to know that the connection of the car rope 2a may be variously changed.

Actually, the drive pulley 6a may be connected to the traction machine or the like, and the traction machine may include an electric motor.

The car 1a may move upward or downward in accordance with a rotation direction of the drive pulley 6a.

The drive device related to one car 1a illustrated in FIG. 10 may operate independently of the devices installed to connect the counterweight to one car 1a illustrated in FIGS. 1 to 9 without being connected directly to the devices.

The example and the description related to one car 1a illustrated in FIGS. 1 to 9 may also be applied to the other cars 1b and 1c in the same way, such that the two car pulleys 4b and 4c may be installed on each of the cars 1b and 1c, and the drive pulley connection car ropes 2b and 2c may be used to connect the car pulleys 4b and 4c to the one-pulley-built-in drive pulleys 6b and 6c connected to the traction machine or the like.

FIG. 11 illustrates a state in which the part related to the counterweight rope 22 connected to the counterweight 21 illustrated in FIGS. 1 to 7 is integrated with a drive device part illustrated in FIG. 10 in respect to one car 1a. The fixed pulleys 19 are installed so that the middle portions of the counterweight rope 22 and the middle portions of the car rope 2a are not in contact with one another.

In the case of the other cars 1b and 1c illustrated in FIGS. 1 to 7, the part related to the counterweight rope 22 connected to the counterweight 21 illustrated in FIGS. 1 to 7 may be integrated with the drive device part illustrated in FIG. 10 in the same way.

The number of cars 1a, 1b, and 1c, the types of car ropes 2a, 2b, and 2c, and the type of counterweight rope 22 are not limited.

When the above-mentioned installation is completed on the cars 1a, 1b, and 1c illustrated in FIGS. 1 to 7, the half of the weight, which excludes the weight of the counterweight function applied by the counterweight rope 22 from the weight of the car 1a, is applied to one one-pulley-built-in drive pulley 6a and the car rope 2a. Even in the case of the other cars 1b and 1c, the half of the weight, which excludes the weight of the counterweight function applied by the counterweight rope 22 from the weights of the cars 1b and 1c, is applied to the one-pulley-built-in drive pulleys 6b and 6c and the car ropes 2b and 2c.

In FIG. 11, eight imaginary radial straight lines, which are formed in dotted line shapes at predetermined angles in different directions from a center vertical line of the car 1a, are provided above the car 1a. The drive pulley connection car pulleys 4a are respectively installed, one by one, at two opposite ends of one of the radial straight line. The counterweight rope connection car pulleys 5a are respectively installed, one by one, at two opposite ends of another radial straight line. The drive pulley connection car pulley 4a and the counterweight rope connection car pulley 5a may be installed to have different heights. The drive pulley connection car pulley 4a and the counterweight rope connection car pulley 5a, which are installed above the imaginary radial straight lines formed in the different directions, may implement an effect of connecting the car rope 2a and the counterweight rope 22 to a center of the car 1a and prevent the car rope 2a and the counterweight rope 22 from being in contact with each other. In addition, the positions of the drive pulley connection car pulley 4a, the counterweight rope connection car pulley 5a, the drive pulley 6a, and the fixed pulley 19 are selected to slightly deviate from the edge of the car 1a, such that the car rope 2a and the counterweight rope 22 are not in contact with the car 1a connected directly thereto and also are not in contact with the other cars 1b and 1c in the elevator shaft.

Even in the case of the other cars 1b and 1c that are not illustrated in FIG. 11, the car rope connection car pulleys 4b and 4c, the counterweight rope connection car pulleys 5b and 5c, the drive pulleys 6b and 6c, and the fixed pulley 19 are installed in the same way, such that the car ropes 2b and 2c and the counterweight rope 22 are prevented from being in contact with one another and the other cars 1a, 1b, and 1c.

It can be easily understood from the description described with reference to FIG. 11 that the part related to the car rope 3a illustrated in FIGS. 8 to 9 is integrated with the drive device part illustrated in FIG. 10 in respect to one car 1a.

FIG. 12 illustrates another example of the drive device capable of being used for the cars 1a, 1b, and 1c illustrated in FIGS. 1 to 9. It can be seen that the fixing rod 13a, the drive pulley connection car pulley 4a, and the one-pulley-built-in drive pulley 6a are installed on one car 1a, and the car rope 2a is used to connect the car pulley 4a and the drive pulley 6a. With the properties of the drive pulley 6a, one end of the car rope 2a is fixed to the fixing rod 13a fixed to the car 1a, and the other end of the car rope 2a may be wound around the drive pulley 6a, extended toward one side past the drive pulley 6a, or wound around a separate wheel such as a rope winding drum.

In FIG. 12, the drive pulley 6a may be changed to the two-pulley-built-in drive pulley 7a illustrated in FIG. 15, and the two opposite ends of the car rope 2a may be respectively connected to the two pulleys of the two-pulley-built-in drive pulley 7a. To this end, the fixing rod 13a needs to be changed to the drive pulley connection car pulley 4a. In addition, the two fixed pulley 19 illustrated at the top side may be excluded, the middle portion of the car rope 2a may be cut, and the two opposite ends of the car rope 2a may be fixed.

The fixed pulley 19, the car pulley 4a, and the fixing rod 13a are installed so that the middle portions of the car rope 2a are not in contact with each other.

From the above-mentioned description, it is sufficient to know that the connection of the car rope 2a may be variously changed.

Actually, the drive pulley 6a may be connected to the traction machine or the like, and the traction machine may include the electric motor.

The car 1a may move upward or downward in accordance with a rotation direction of the drive pulley 6a.

The drive device related to the car 1a illustrated in FIG. 12 may operate independently of the devices installed to connect the counterweight to one car 1a illustrated in FIGS. 1 to 9 without being connected directly to the devices.

The example and the description related to one car 1a illustrated in FIGS. 1 to 9 may also be applied to the other cars 1b and 1c in the same way, such that the fixing rods 13b and 13c, the car pulleys 4b and 4c, and the one-pulley-built-in drive pulleys 6b and 6c may be respectively installed on the cars 1b and 1c, and the car ropes 2b and 2c may be used to connect the car pulleys 4b and 4c and the drive pulleys 6b and 6c.

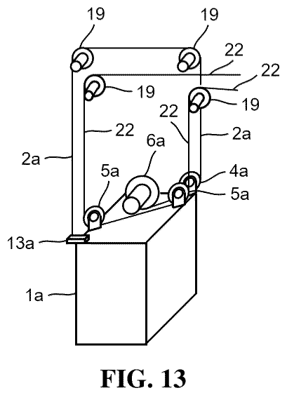

FIG. 13 illustrates a state in which the part related to the counterweight rope 22 connected to the counterweight 21 illustrated in FIGS. 1 to 7 is integrated with a drive device part illustrated in FIG. 12 in respect to one car 1a. The fixed pulleys 19 and the fixing rod 13a are installed so that the middle portions of the counterweight rope 22 and the middle portions of the car rope 2a are not in contact with one another.

In the case of the other cars 1b and 1c illustrated in FIGS. 1 to 7, the part related to the counterweight rope 22 connected to the counterweight 21 illustrated in FIGS. 1 to 7 may be integrated with the drive device part illustrated in FIG. 12 in the same way.

The number of cars 1a, 1b, and 1c, the types of car ropes 2a, 2b, and 2c, and the type of counterweight rope 22 are not limited.

When the above-mentioned installation is completed on the cars 1a, 1b, and 1c illustrated in FIGS. 1 to 7, the half of the weight, which excludes the weight of the counterweight function applied by the counterweight rope 22 from the weight of the car 1a, is applied to one one-pulley-built-in drive pulley 6a and the car rope 2a. Even in the case of the other cars 1b and 1c, the half of the weight, which excludes the weight of the counterweight function applied by the counterweight rope 22 from the weights of the cars 1b and 1c, is applied to the one-pulley-built-in drive pulleys 6b and 6c and the car ropes 2b and 2c.

Even in the case of the other cars 1b and 1c that are not illustrated in FIG. 13, the car rope connection car pulleys 4b and 4c, the counterweight rope connection car pulleys 5b and 5c, the fixing rods 13b and 13c, the drive pulleys 6b and 6c, and the fixed pulley 19 are installed in the same way, such that the car ropes 2b and 2c and the counterweight rope 22 are prevented from being in contact with one another and the other cars 1a, 1b, and 1c.

It can be easily understood from the description described with reference to FIG. 13 that the part related to the car rope 3a illustrated in FIGS. 8 to 9 is integrated with the drive device part illustrated in FIG. 12 in respect to one car 1a.

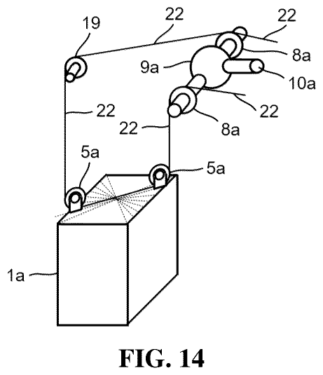

FIG. 14 illustrates another example of the drive device capable of being used for the cars 1a, 1b, and 1c illustrated in FIGS. 1 to 7. The drive device is characterized by including the differential 9a. It can be seen that the part related to the counterweight rope 22 connected to the counterweight 21 illustrated in FIGS. 1 to 7 is integrated with the drive device part including the differential 9a in respect to one car 1a. The differential 9a and the two drive pulleys 8a connected to either side of the differential, are further used for one car 1a, the two drive pulleys 8a are respectively connected to the two counterweight ropes 22, and the two drive pulleys 8a are respectively connected to two opposite shafts of the differential 9a. The fixed pulleys 19 and the drive pulley 8a are installed so that middle portions of the counterweight rope 22 do not come into contact with each other.

Even in the case of the other cars 1b and 1c illustrated in FIGS. 1 to 7, differentials 9b and 9c and drive pulleys 8b and 8c, which are connected to the differentials, may be further used to configure the car 1a illustrated in FIG. 14 in the same way.

The number of cars 1a, 1b, and 1c and the type of counterweight rope 22 are not limited. The differential 9a may be, but not limited to, an open differential.

The differential 9a receives power through the drive shaft 10a of the differential 9a. Actually, the drive shaft 10a of the differential 9a may be connected to the traction machine or the like. The traction machine may include the electric motor.

Operations of the car 1a and the counterweight 21 in accordance with the use of the differential 9a will be described. Because the two drive pulleys 8a may rotate by the same angle in the opposite directions even in a state in which the drive shaft 10a of the differential 9a is stopped, the counterweight rope 22 may freely move while the car 1a is stopped. In this case, when the drive shafts 10a of the differential 9a rotate, the two drive pulleys 8a may additionally rotate, such that the car 1a may be moved.

The car 1a may move upward or downward in accordance with a rotation direction of the drive shaft 10a of the differential 9a.

The weight of the counterweight function applied by the counterweight rope 22 is applied to the two drive pulleys 8a.

When the above-mentioned installation is completed on the cars 1a, 1b, and 1c illustrated in FIGS. 1 to 7, the weight of one car 1a is applied to the connected counterweight rope 22, and the counterweight rope 22 is connected to the two drive pulleys 8a. The counterweight rope 22 connected to the drive pulley 8a is pulled by the weight of the counterweight function applied by the counterweight 21. Therefore, the weight, which excludes the weight of the counterweight function from the weight of the car 1a, is applied to the drive shaft 10a of the differential 9a connected to the drive pulley 8a. Even in the case of the other cars 1b and 1c, the weights of the cars 1b and 1c are applied to the connected counterweight rope 22, and the counterweight rope 22 is connected to the drive pulleys 8b and 8c and pulled by the weight of the counterweight function applied by the counterweight 21, such that the weight, which excludes the weight of the counterweight function from the weights of the cars 1b and 1c, is applied to drive shafts 10b and 10c of the differentials 9b and 9c connected to the drive pulleys 8b and 8c.

FIG. 15 illustrates another example in which the two-pulley-built-in drive pulleys 7a, 7b, and 7c, which are capable of operating the cars 1a, 1b, and 1c, are connected in respect to the counterweight 21, the counterweight rope 22, the counterweight pulley 23, the middle pulleys 18a, 18b, and 18c, the car ropes 3a, 3b, and 3c, the fixing rods 12a and 12b, the car pulleys 5c, and the cars 1a, 1b, and 1c illustrated in FIG. 8. The two pulleys of one of the drive pulleys 7a, 7b, and 7c are connected to the car ropes 3a, 3b, and 3c connected to one of the cars 1a, 1b, and 1c. The two pulleys of the drive pulleys 7a, 7b, and 7c are fixed to the shaft and rotate always together. Because the car ropes 3a, 3b, and 3c are connected to the counterweight rope 22 through the middle pulleys 18a, 18b, and 18c, a part of the weight of the counterweight 21 is applied as the weight of the counterweight function to the cars 1a, 1b, and 1c when the cars 1a, 1b, and 1c to which the drive pulleys 7a, 7b, and 7c are connected are operated.

It can be seen from the above-mentioned description that the two-pulley-built-in drive pulleys 7a, 7b, and 7c capable of operating the cars 1a, 1b, and 1c may be connected to those illustrated in FIG. 9 in the same way.

The weight, which excludes the weight of the counterweight function applied by the car ropes 3a, 3b, and 3c from the weights of the cars 1a, 1b, and 1c, is applied to one of the drive pulleys 7a, 7b, and 7c.

The fixed pulley 19 and the drive pulleys 7a, 7b, and 7c are installed so that the middle portions of the counterweight rope 22 and the middle portions of the car ropes 3a, 3b, and 3c are not in contact with one another.

The cars 1a, 1b, and 1c move upward or downward in accordance with the rotations of the drive pulleys 7a, 7b, and 7c.

The positions of the cars 1a, 1b, and 1c illustrated in FIG. 15 are spread to allow a connection relationship of the car ropes 3a, 3b, and 3c to be easily recognized and assist in understanding the present invention. Actually, the cars 1a, 1b, and 1c are disposed in the single elevator shaft. The positions of the cars 1a, 1b, and 1c may be adjusted by adjusting the positions of the fixed pulleys 19.

The number of cars 1a, 1b, and 1c and the type of counterweight rope 22 are not limited.

Actually, the drive pulleys 7a, 7b, and 7c may be connected to the traction machine or the like. The traction machine may include the electric motor.

FIG. 15 illustrates an example in which the counterweight 21 and the cars 1a, 1b, and 1c are connected. Actual positions of the cars 1a, 1b, and 1c are disposed in the single elevator shaft so as not to collide with one another upward and downward in the elevator shaft.

In case that all the cars 1a, 1b, and 1c in FIG. 15 simultaneously move 1 m in the same direction, all the middle pulleys 18a, 18b, and 18c move ½ m, and the counterweight 21 also moves ½ m. Therefore, it is necessary to analyze a sum of the movement distances of the middle pulleys 18a, 18b, and 18c and the movement distance of the counterweight 21.

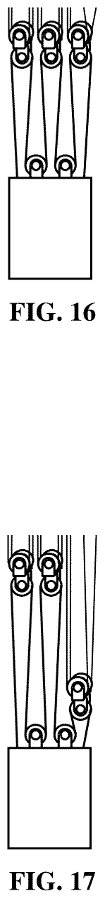

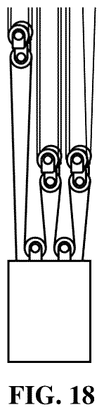

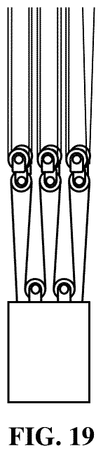

It is possible to identify a length required for the counterweight rope 22 illustrated in FIG. 15 by means of the analyses in FIGS. 16 to 19. It is assumed that the cars 1a, 1b, and 1c each travel from the top to the bottom of the elevator shaft or travel along a section with a predetermined distance, and the traveling distances are equal to one another. The counterweight rope 22 needs to ensure the movements of the cars 1a, 1b, and 1c from an upper end to a lower end of a section along which the cars 1a, 1b, and 1c travel. In FIG. 16, all the middle pulleys 18a, 18b, and 18c are provided at the upper ends. In FIG. 19, all the middle pulleys 18a, 18b, and 18c are provided at the lower ends by being spaced by ½ of the traveling distance of each of the cars 1a, 1b, and 1c. In FIG. 17, one middle pulley 18a is provided at the lower end. In FIG. 18, the two middle pulleys 18a and 18b are provided at the lower ends. An allowable minimum length of the counterweight rope 22 may be easily identified in FIG. 17. This is because the length of the counterweight rope 22 cannot be shorter than the length of the counterweight rope 22 illustrated in FIG. 17. For this reason, in FIG. 16, the counterweight 21 cannot be close to the upper end and spaced apart from the upper end by 2/6 of the traveling distance of each of the cars 1a, 1b, and 1c. As illustrated in FIG. 16, 2/6×6= 12/6 is made by adding up the lengths of the counterweight rope 22 from the left side to the right side, and ½×4=2 is calculated as illustrated in FIG. 17. Therefore, ⅚ needs to be taken into account by adding up the spacing distance of 2/6 and the movement distance of ½ of the counterweight 21. That is, the traveling distance of the car may be limited to Traveling Distance of Car×⅚=Length of Elevator Shaft.

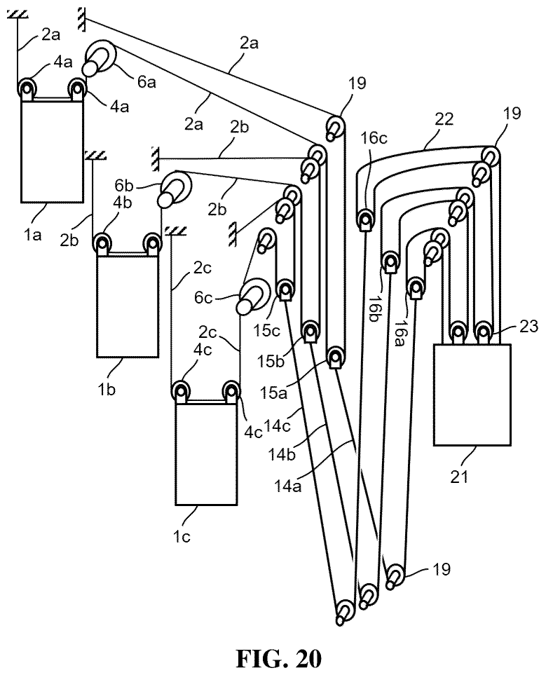

FIG. 20 illustrates another example in which the one-pulley-built-in drive pulleys 6a, 6b, and 6c, the counterweight 21, and the cars 1a, 1b, and 1c are connected in respect to the plurality of cars 1a, 1b, and 1c installed in the single elevator shaft. The car ropes 2a, 2b, and 2c, the car pulleys 4a, 4b, and 4c, the drive pulleys 6a, 6b, and 6c, the counterweight 21, the counterweight pulley 23, and the counterweight rope 22 are used. The three car ropes 2a, 2b, and 2c having the two opposite ends fixed to the three cars 1a, 1b, and 1c are respectively connected to the car pulleys 4a, 4b, and 4c, the drive pulleys 6a, 6b, and 6c, and the car side middle pulleys 15a, 15b, and 15c. In addition, as illustrated in FIG. 1, the counterweight rope 22 connected to the counterweight 21 is connected to the counterweight side middle pulleys 16a, 16b, and 16c, and the car side middle pulleys 15a, 15b, and 15c and the counterweight side middle pulleys 16a, 16b, and 16c are connected through the middle ropes 14a, 14b, and 14c. Therefore, the part of the weight of the counterweight 21 is applied as the weight of the counterweight function to the cars 1a, 1b, and 1c when the cars 1a, 1b, and 1c to which the drive pulleys 6a, 6b, and 6c are connected are operated. e fixed pulleys 19 are installed so that the middle portions of the car ropes 2a, 2b, and 2c, the middle portions of the middle ropes 14a, 14b, and 14c, and the middle portions of the counterweight rope 22 are not in contact with one another. The positions of the cars 1a, 1b, and 1c illustrated in FIG. 20 are spread to allow a connection relationship of the counterweight rope 22 to be easily recognized and assist in understanding the present invention. Actually, the cars 1a, 1b, and 1c are disposed in the single elevator shaft. The positions of the cars 1a, 1b, and 1c may be adjusted by adjusting the positions of the fixed pulleys 19.

The number of cars 1a, 1b, and 1c, the types of car ropes 2a, 2b, and 2c, the types of middle ropes 14a, 14b, and 14c, and the type of counterweight rope 22 are not limited.

The weight of the counterweight function applied to each of the cars 1a, 1b, and 1c by the weight of one counterweight 21 will be described with reference to FIG. 20. The weight of the counterweight 21 is dispersed to the counterweight rope 22 attached six times. Therefore, a weight of ⅙ of the weight of the counterweight 21 is applied to the counterweight rope 22. The counterweight rope 22 is attached to each of the middle ropes 14a, 14b, and 14c two times through the counterweight side middle pulleys 16a, 16b, and 16c, such that 2/6 of the weight of the counterweight 21 is applied. The car ropes 2a, 2b, and 2c are connected to the middle ropes 14a, 14b, and 14c through the car side middle pulleys 15a, 15b, and 15c, and the car ropes 2a, 2b, and 2c are attached to the car side middle pulleys 15a, 15b, and 15c two times, such that ⅙ of the weight of the counterweight 21 is applied to each of the car ropes 2a, 2b, and 2c. The car ropes 2a, 2b, and 2c are attached to the cars 1a, 1b, and 1c two times through the two car pulleys 4a, 4b, and 4c, such that the weight of 2/6 of the weight of the counterweight 21 is applied as the weight of the counterweight function in respect to the cars 1a, 1b, and 1c. The half of the weight, which excludes the weight of the counterweight function applied by the counterweight rope 22 from the weights of the cars 1a, 1b, and 1c, is applied to one of the drive pulleys 6a, 6b, and 6c.

When one of the cars 1a, 1b, and 1c moves 1 m, the lengths of the car ropes 2a, 2b, and 2c, which hold the cars 1a, 1b, and 1c are changed by 2 m. The change of the lengths of the car ropes 2a, 2b, and 2c by 2 m moves the connected car side middle pulleys 15a, 15b, and 15c by 1 m. When the car side middle pulleys 15a, 15b, and 15c move 1 m, the counterweight side middle pulleys 16a, 16b, and 16c, which are connected to the car side middle pulleys 15a, 15b, and 15c through the middle ropes 14a, 14b, and 14c, also move 1 m, such that the length of the counterweight rope 22, which holds the counterweight 21, is changed by 2 m, and the counterweight 21 moves 2/6 m. Therefore, with reference to FIG. 20, the counterweight 21 moves a ⅓ distance in the direction opposite to the movement distance of each of the cars 1a, 1b, and 1c. When all the cars 1a, 1b, and 1c move 1 m in the same direction, the counterweight 21 moves 1 m in the opposite direction. At this point, there is no need to be concerned about the maximum movement distance of the counterweight 21.

The two opposite ends of the car ropes 2a, 2b, and 2c illustrated in FIG. 20 may be connected to each other.

The method of connecting the counterweight 21, the counterweight rope 22, and the counterweight pulley 23 illustrated in FIG. 20 may be identical to the method illustrated in FIG. 1. This method may be changed to various methods described with reference to various views in FIGS. 2 to 6 in addition to the above-mentioned description.

In addition, in FIG. 20, the car 1c, the car rope 2c, the car pulley 4c, the one-pulley-built-in drive pulley 6c, and the car rope connection middle pulley 15c may be excluded, and one end of the middle rope 14c may be connected to one of the car side middle pulleys 15a and 15b to which the other middle ropes 14a and 14b are connected. With the above-mentioned change, the cars 1a and 1b to which one middle rope 14c is further connected receive a force of the weight of the counterweight 21 corresponding to two times the weights of the other cars 1b and 1a from the counterweight 21. This change allows one of the cars 1a and 1b to be used for special purposes, like a freight car.

It can be seen from the above-mentioned description that the connection of the counterweight rope 22 may be variously changed.

FIG. 20 illustrates an example in which the counterweight 21 and the cars 1a, 1b, and 1c are connected. Actual positions of the cars 1a, 1b, and 1c are disposed in the single elevator shaft so as not to collide with one another upward and downward in the elevator shaft. The method of preventing the middle portions of the car ropes 2a, 2b, and 2c from coming into contact with one another will be identified from the above-mentioned description described with reference to FIG. 11.

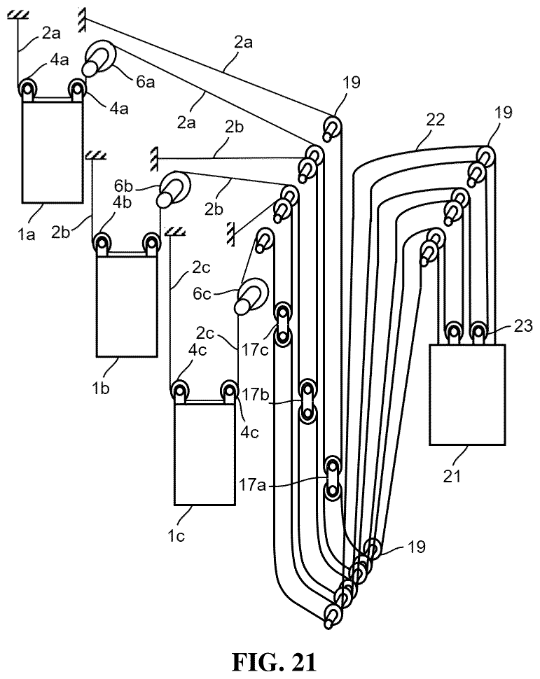

FIG. 21 is a modified example of FIG. 20 and illustrates an example in which the middle ropes 14a, 14b, and 14c illustrated in FIG. 20 are excluded, the car side middle pulleys 15a, 15b, and 15c and the counterweight side middle pulleys 16a, 16b, and 16c are integrated into two-pulley-built-in middle pulleys 17a, 17b, and 17c, and the counterweight rope 22 is further extended.

A detailed operation of the example illustrated in FIG. 21 will be understood from the description described with reference to FIG. 20.

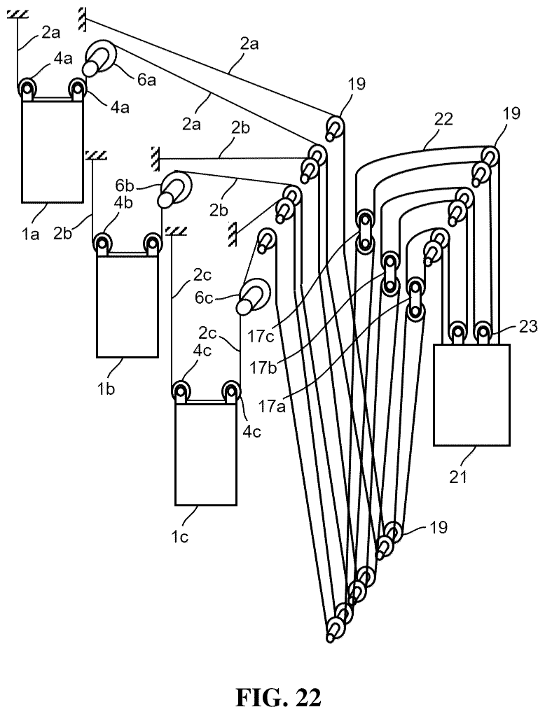

FIG. 22 is a modified example of FIG. 21 and illustrates an example in which the counterweight rope 22 is shortened, and instead, the car ropes 2a, 2b, and 2c are elongated.

A detailed operation of the example illustrated in FIG. 22 will be understood from the description described with reference to FIG. 20.

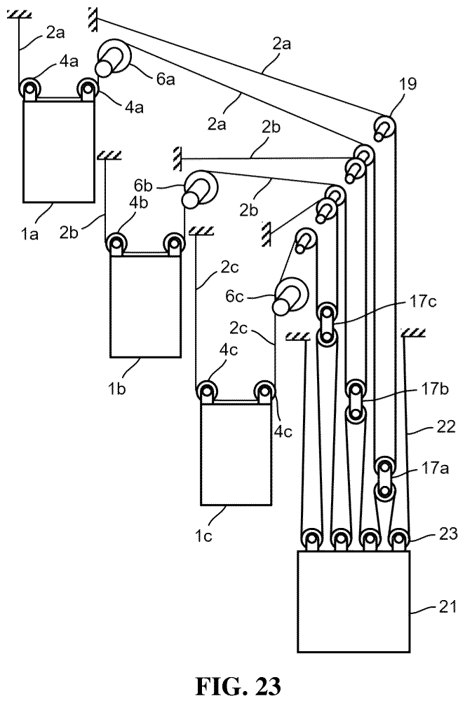

FIG. 23 is a modified example of FIG. 21 and illustrates an example in which the counterweight 21 is positioned at a position below the middle pulleys 17a, 17b, and 17c, and the method of connecting the counterweight rope 22 is changed. In FIG. 23, unlike in FIG. 21, the four counterweight pulleys 23 are installed as movable pulleys on the counterweight 21, and the two opposite ends of the counterweight rope 22 are fixed.

When the counterweight 21 is positioned below the middle pulleys 17a, 17b, and 17c, there occurs a problem that has not been considered in FIGS. 20 to 22. In FIG. 21, when all the cars 1a, 1b, and 1c move from the bottom to the top of the elevator shaft, all the middle pulleys 17a, 17b, and 17c may move from the top to the bottom of the elevator shaft, and the counterweight 21 may also move the top to the bottom of the elevator shaft. However, in FIG. 23, when all the cars 1a, 1b, and 1c move from the bottom to the top of the elevator shaft, all the middle pulleys 17a, 17b, and 17c may move from the top to the bottom of the elevator shaft. If the counterweight 21, the two counterweight pulleys 23, and the counterweight rope 22 illustrated in FIG. 21 are moved to the positions below the middle pulleys 17a, 17b, and 17c in the same way, the counterweight 21 has nowhere to go on the bottom in the elevator shaft when the middle pulleys 17a, 17b, and 17c are moved to the bottom of the elevator shaft. That is, the use of the counterweight 21 and the counterweight rope 22 at the positions below the middle pulleys 17a, 17b, and 17c is restricted.

In FIG. 23, because the middle pulleys 17a, 17b, and 17c move 1 m even though the counterweight 21 moves 1 m when all the cars 1a, 1b, and 1c move 1 m in the same direction while the connection between the counterweight rope 22 and the counterweight 21 using the two counterweight pulleys 23 illustrated in FIG. 21 is used in an intact manner, the middle pulleys 17a, 17b, and 17c and the counterweight 21 may divide and use the overall length of the elevator shaft. Therefore, this shape in FIG. 23 may be used only in a case in which the cars 1a, 1b, and 1c travel in the separated sections, and the traveling section of each of the cars 1a, 1b, and 1c is shorter than the length of the elevator shaft.

Because the four counterweight pulleys 23 are used in case that the counterweight 21 illustrated in FIG. 23 is used in an intact manner, it is possible to implement an effect of making the movement distance of the counterweight 21 shorter than that of the counterweight 21 using the two counterweight pulleys 23 illustrated in FIG. 21.

In FIG. 23, the four counterweight pulleys 23 are used. The configuration in which the number of counterweight pulleys 23 is increased and the counterweight rope 22 is connected as described above helps to reduce the movement distance of the counterweight 21. However, because the weight of the counterweight 21 is reduced when the weight of the counterweight 21 is applied as the weight of the counterweight function to the cars 1a, 1b, and 1c, the weight of the counterweight 21 sometimes needs to be increased.

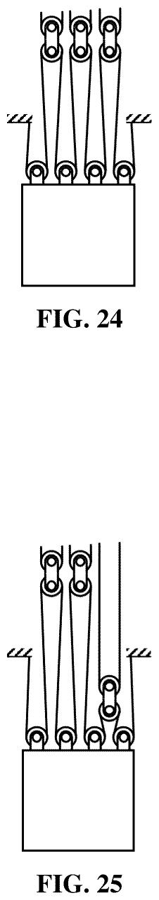

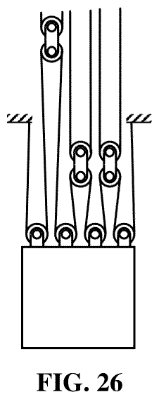

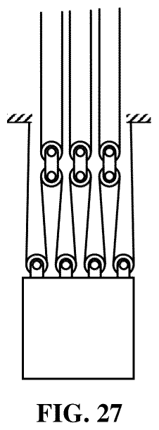

FIGS. 24 to 27 are provided to identify the length of the counterweight rope 22 required for the counterweight 21 and the counterweight rope 22 illustrated in FIG. 23. It is assumed that the cars 1a, 1b, and 1c each travel from the top to the bottom of the elevator shaft or travel along a section with a predetermined distance, and the traveling distances are equal to one another. The counterweight rope 22 needs to ensure the movements of the cars 1a, 1b, and 1c from an upper end to a lower end of a section along which the cars 1a, 1b, and 1c travel. In FIG. 24, all the middle pulleys 17a, 17b, and 17c are provided at the upper ends. In FIG. 27, the middle pulleys 17a, 17b, and 17c are provided at the lower ends by being spaced by the traveling distance of each of the cars 1a, 1b, and 1c. FIG. 25 illustrates a state in which only one middle pulley 17a is provided at the lower end. An allowable minimum length of the counterweight rope 22 may be easily identified in FIG. 25. This is because the length of the counterweight rope 22 cannot be shorter than the length of the counterweight rope 22 illustrated in FIG. 25. For this reason, in FIG. 24, the counterweight 21 cannot be provided at the upper end and spaced apart from the upper end by ¾ of the traveling distance of each of the cars 1a, 1b, and 1c. In FIG. 24, when 0.25+0.75+0.75+0.75+0.75+0.75+0.75+0.25=5 is made by adding up the lengths of the counterweight rope 22 from the left side to the right side, 0.5+1+1+1+1+0+0+0.5=5 is made, as illustrated in FIG. 25. When the length of the counterweight rope 22 is determined, the traveling distance and the traveling section of the counterweight 21 may also be identified in respect to the weight of the function of the counterweight 21 applied to the cars 1a, 1b, and 1c and the traveling distances of the cars 1a, 1b, and 1c by means of the analyses in FIGS. 24 to 27.

The weight of the counterweight 21 is dispersed to the counterweight rope 22 attached eight times. Therefore, a weight of 1/8 of the weight of the counterweight 21 is applied to the counterweight rope 22. The counterweight rope 22 is attached to each of the middle pulleys 17a, 17b, and 17c two times, such that 2/8 of the weight of the counterweight 21 is applied. The car ropes 2a, 2b, and 2c are each attached to each of the middle pulleys 17a, 17b, and 17c two times, such that ⅛ of the weight of the counterweight 21 is applied. The cars 1a, 1b, and 1c are each attached to each of the car ropes 2a, 2b, and 2c two times, such that 2/8 of the weight of the counterweight 21 is applied as the weight of the counterweight function.

When the cars 1a, 1b, and 1c move 1 m, the middle pulleys 17a, 17b, and 17c also move 1 m in the opposite direction. When one of the middle pulleys 17a, 17b, and 17c moves 1 m, the length of the connected counterweight rope 22 is changed by 2 m, and the change moves the counterweight 21 by 2/8 m. When all the cars 1a, 1b, and 1c simultaneously move 1 m in the same direction, the counterweight 21 moves 6/8 m.

Therefore, according to the calculation result showing that the counterweight 21 needs to be spaced apart from the top of the elevator shaft, 12/8 needs to be considered by adding up ¾ and the distance of 6/8 that the counterweight 21 moves when all the cars 1a, 1b, and 1c simultaneously move in the same direction. The traveling distance of the car may be limited to Traveling Distance of Car× 12/8=Length of Elevator Shaft.

FIG. 28 is a view for analyzing the length of the counterweight rope 22 in case that the four counterweight pulleys 23 installed on the counterweight 21 illustrated in FIGS. 23 to 27 are changed to two counterweight pulleys 23, the counterweight rope 22 is connected, and the two opposite ends of the counterweight rope 22 are fixed to the counterweight 21. The counterweight 21 is spaced apart from the upper ends, at which the middle pulleys 17a, 17b, and 17c are provided, by about ⅔ of the traveling distance of each of the cars 1a, 1b, and 1c without being provided at the upper ends at which the middle pulleys 17a, 17b, and 17c are provided. When 2/6 of the counterweight 21 is applied as the weight of the counterweight function to each of the cars 1a, 1b, and 1c and all the cars 1a, 1b, and 1c simultaneously move 1 m in the same direction, the counterweight 21 moves 6/6 m. The traveling distance of the car may be limited to Traveling Distance of Car× 10/6=Length of Elevator Shaft.

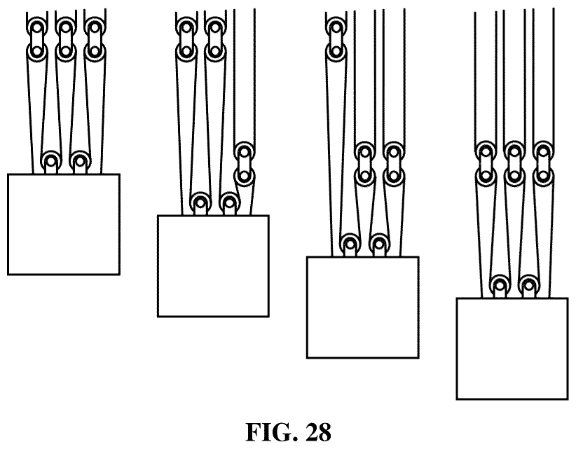

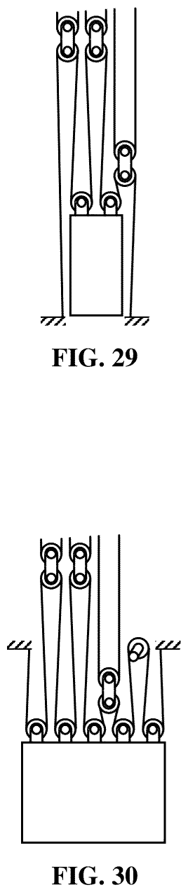

FIG. 29 illustrates a case in which the two counterweight pulleys 23 illustrated in FIG. 28 are used in an intact manner, and the two opposite ends of the counterweight rope 22 are fixed without being fixed to the counterweight 21.

FIG. 30 illustrates a case in which the four counterweight pulleys 23 illustrated in FIGS. 24 to 27 are changed to five counterweight pulleys 23, and the counterweight rope 22 is connected.

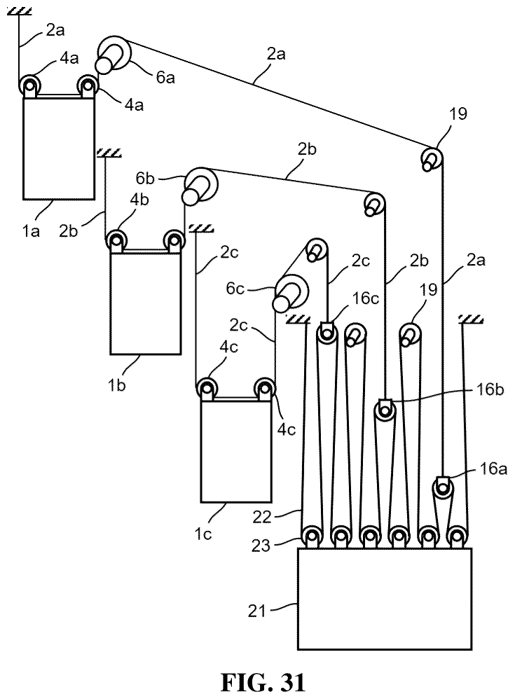

FIG. 31 illustrates another example in which the one-pulley-built-in drive pulleys 6a, 6b, and 6c, the counterweight 21, and the cars 1a, 1b, and 1c are connected in respect to the plurality of cars 1a, 1b, and 1c installed in the single elevator shaft. The car ropes 2a, 2b, and 2c, the car pulleys 4a, 4b, and 4c, the drive pulleys 6a, 6b, and 6c, the counterweight 21, the counterweight pulley 23, the counterweight rope 22, and the counterweight side middle pulleys 16a, 16b, and 16c are used. The three car ropes 2a, 2b, and 2c each having one end fixed to each of the three cars 1a, 1b, and 1c are respectively connected to the car pulleys 4a, 4b, and 4c, and the drive pulleys 6a, 6b, and 6c, and the other end of each of the three car ropes 2a, 2b, and 2c is connected to each of the counterweight side middle pulleys 16a, 16b, and 16c. The counterweight rope 22, which is connected to the counterweight 21 through the six counterweight pulleys 23, is connected to the counterweight side middle pulleys 16a, 16b, and 16c. Therefore, the part of the weight of the counterweight 21 is applied as the weight of the counterweight function to the cars 1a, 1b, and 1c when the cars 1a, 1b, and 1c to which the drive pulleys 6a, 6b, and 6c are connected are operated.

The fixed pulleys 19 are installed so that the middle portions of the car ropes 2a, 2b, and 2c and the middle portions of the counterweight rope 22 are not in contact with one another. The positions of the cars 1a, 1b, and 1c illustrated in FIG. 31 are spread to allow a connection relationship of the counterweight rope 22 to be easily recognized and assist in understanding the present invention. Actually, the cars 1a, 1b, and 1c are disposed in the single elevator shaft. The positions of the cars 1a, 1b, and 1c may be adjusted by adjusting the positions of the fixed pulleys 19.

The number of cars 1a, 1b, and 1c, the types of car ropes 2a, 2b, and 2c, and the type of counterweight rope 22 are not limited.

The weight of the counterweight function applied to each of the cars 1a, 1b, and 1c by the weight of one counterweight 21 will be described with reference to FIG. 31. The weight of the counterweight 21 is dispersed to the counterweight rope 22 attached twelve times. Therefore, a weight of 1/12 of the weight of the counterweight 21 is applied to the counterweight rope 22. The counterweight rope 22 is attached to each of the counterweight side middle pulleys 16a, 16b, and 16c two times, such that 2/12 of the weight of the counterweight 21 is applied, and 2/12 of the weight of the counterweight 21 is applied, in an intact manner, even to the car ropes 2a, 2b, and 2c connected directly to the counterweight side middle pulleys 16a, 16b, and 16c. The car ropes 2a, 2b, and 2c are attached to the cars 1a, 1b, and 1c through the two car pulleys 4a, 4b, and 4c two times, such that 4/12 of the weight of the counterweight 21 is applied as the weight of the counterweight function to each of the cars 1a, 1b, and 1c. The half of the weight, which excludes the weight of the counterweight function applied by the counterweight rope 22 from the weights of the cars 1a, 1b, and 1c, is applied to one of the drive pulleys 6a, 6b, and 6c.

When one of the cars 1a, 1b, and 1c moves 1 m, the lengths of the car ropes 2a, 2b, and 2c, which hold the cars 1a, 1b, and 1c are changed by 2 m. The change of the lengths of the car ropes 2a, 2b, and 2c by 2 m also moves the connected counterweight side middle pulleys 16a, 16b, and 16c by 2 m, and this movement changes the length of the counterweight rope 22, which holds the counterweight 21, by 4 m and allows the counterweight 21 to move 4/12 m. Therefore, with reference to FIG. 31, the counterweight 21 moves a ⅓ distance in the direction opposite to the movement distance of each of the cars 1a, 1b, and 1c. When all the cars 1a, 1b, and 1c move 1 m in the same direction, all the counterweight side middle pulleys 16a, 16b, and 16c move 2 m, whereas the counterweight 21 moves 1 m.

In FIG. 31, because the counterweight side middle pulleys 16a, 16b, and 16c move 2 m even though the counterweight 21 moves 1 m when all the cars 1a, 1b, and 1c move 1 m in the same direction, the counterweight side middle pulleys 16a, 16b, and 16c and the counterweight 21 may divide and use the overall length of the elevator shaft. This configuration may suit a case in which the traveling section of each of the cars 1a, 1b, and 1c is shorter than the length of the elevator shaft, such as a case in which the cars 1a, 1b, and 1c travel the separated sections with predetermined distances.

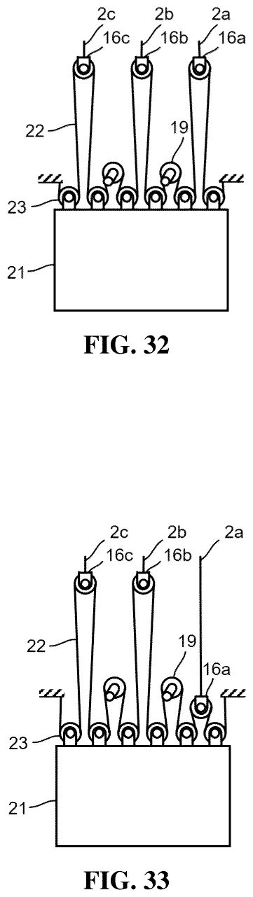

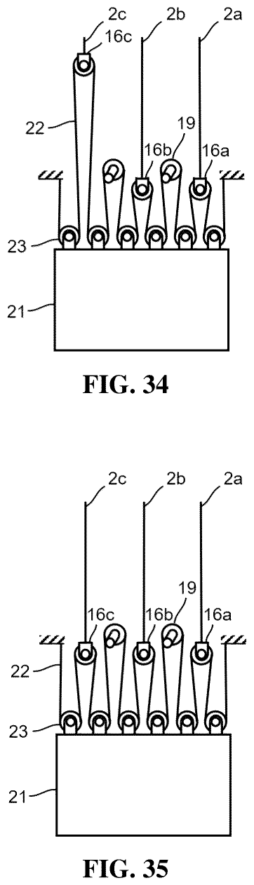

FIGS. 32 to 35 are provided to identify the length of the counterweight rope 22 required for the counterweight 21 and the counterweight rope 22 illustrated in FIG. 31. It is assumed that the cars 1a, 1b, and 1c each travel from the top to the bottom of the elevator shaft or travel along a section with a predetermined distance, and the traveling distances are equal to one another. The counterweight rope 22 needs to ensure the movements of the cars 1a, 1b, and 1c from an upper end to a lower end of a section along which the cars 1a, 1b, and 1c travel. In FIG. 32, all the counterweight side middle pulleys 16a, 16b, and 16c are provided at the upper ends. In FIG. 35, the middle pulleys 16a, 16b, and 16c are provided at the lower ends by being spaced by two times the traveling distance of each of the cars 1a, 1b, and 1c. FIG. 33 illustrates a state in which only one middle pulley 16a is provided at the lower end. An allowable minimum length of the counterweight rope 22 may be easily identified in FIG. 33. This is because the length of the counterweight rope 22 cannot be shorter than the length of the counterweight rope 22 illustrated in FIG. 33. For this reason, in FIG. 32, the counterweight 21 cannot be provided at the upper end and spaced apart from the upper end by 10/12 of two times the traveling distance of each of the cars 1a, 1b, and 1c. Mathematically, the length of the counterweight rope 22 in FIG. 32 is 0×6+ 10/12×6=5, and 2/12×6+1×4=5 is made in FIG. 33.

When the length of the counterweight rope 22 is determined, the traveling distance and the traveling section of the counterweight 21 may also be identified in respect to the traveling distances of the cars 1a, 1b, and 1c by means of the analyses in FIGS. 32 to 35.

Therefore, according to the calculation result showing that the counterweight 21 needs to be spaced apart from the top of the elevator shaft, 22/12 needs to be considered by adding up 10/12 and the distance of 1 that the counterweight 21 moves when all the cars 1a, 1b, and 1c simultaneously move in the same direction. The traveling distance of the car may be limited to Traveling Distance of Car× 22/12=Length of Elevator Shaft.

It can be seen even from FIG. 31 that the number of counterweight pulleys 23 may increase or decrease. The two counterweight pulleys 23 of the counterweight 21 may be removed one by one, and the two opposite ends of the counterweight rope 22 may be fixed to the bottom.

From the above-mentioned description, it is sufficient to know that the connection of the counterweight rope 22 may be variously changed, and an appropriate connection method may be used, as necessary.

FIG. 31 illustrates an example in which the counterweight 21 and the cars 1a, 1b, and 1c are connected. Actual positions of the cars 1a, 1b, and 1c are disposed in the single elevator shaft so as not to collide with one another upward and downward in the elevator shaft. The method of preventing the middle portions of the counterweight rope 22 from coming into contact with each other is identical to the method in the above-mentioned description described with reference to FIG. 11.

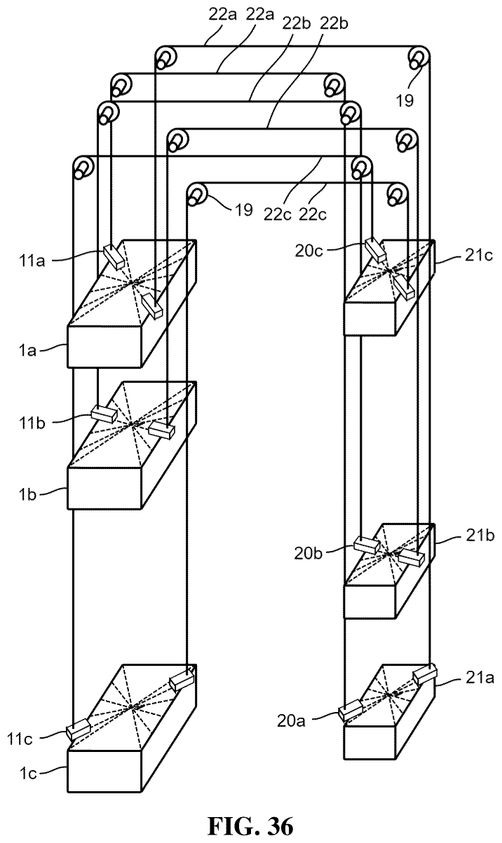

FIG. 36 illustrates an example in which car connection counterweights 21a, 21b, and 21c, which are equal in number to the plurality of cars 1a, 1b, and 1c installed in the single elevator shaft, are used. The counterweight fixing rods 20a, 20b, and 20c are installed two by two on each of the car connection counterweights 21a, 21b, and 21c, the counterweight connection fixing rods 11a, 11b, and 11c are installed two by two on each of the cars 1a, 1b, and 1c, and the counterweight fixing rods 20a, 20b, and 20c and the counterweight connection fixing rods 11a, 11b, and 11c are connected, one by one, to the car connection counterweight ropes 22a, 22b, and 22c.

It can be seen that instead of the fixing rod 12c, the counterweight rope connection car pulley 5c is installed on one car 1c in FIGS. 8, 9, and 15, and the counterweight rope connection car ropes 3c are connected to each other. In the same way, the counterweight rope connection car pulleys 5a, 5b, and 5c may be installed instead of the counterweight connection fixing rods 11a, 11b, and 11c in FIG. 36, or the counterweight pulleys 23 may be installed instead of the counterweight fixing rods 20a, 20b, and 20c. In case that the counterweight rope connection car pulleys 5a, 5b, and 5c or the counterweight pulleys 23 are installed, the counterweight ropes 22a, 22b, and 22c are integrated into one counterweight rope from the state in which the counterweight ropes 22a, 22b, and 22c are separated as two counterweight ropes. In case that all the counterweight rope connection car pulleys 5a, 5b, and 5c and the counterweight pulley 23 are installed, the counterweight ropes 22a, 22b, and 22c may each have a ring shape.

The fixed pulleys 19 are installed so that the middle portions of the car connection counterweight ropes 22a, 22b, and 22c are not in contact with each other. As necessary, pulleys may be installed at lateral sides of some of the cars 1a and 1b and lateral sides of some of the car connection counterweights 21b and 21c to assist in preventing the car connection counterweight ropes 22a, 22b, and 22c from being in contact with the lateral sides. This configuration may be applied in common to all the cars.

FIG. 36 illustrates relationships between the cars 1a, 1b, and 1c and the car connection counterweights 21a, 21b, and 21c disposed in the single elevator shaft. It can be seen that the car connection counterweight ropes 22a, 22b, and 22c are not in contact with the lateral sides of the cars 1a, 1b, and 1c and the car connection counterweights 21a, 21b, and 21c. In case that the cars 1a, 1b, and 1c travel without colliding with one another upward or downward, the car connection counterweights 21a, 21b, and 21c may also not collide with one another upward or downward. The positions of the counterweight fixing rods 20a, 20b, and 20c and the counterweight connection fixing rods 11a, 11b, and 11c may be adjusted.

The number of cars 1a, 1b, and 1c and the types of counterweight ropes 22a, 22b, and 22c are not limited.

The weights of the car connection counterweights 21a, 21b, and 21c are applied to the cars 1a, 1b, and 1c through the connected counterweight ropes 22a, 22b, and 22c.

The movements of the car connection counterweights 21a, 21b, and 21c will be described with reference to FIG. 36. The movement distance of each of the car connection counterweights 21a, 21b, and 21c is equal to the movement distance of each of the cars 1a, 1b, and 1c connected to the car connection counterweight ropes 22a, 22b, and 22c and is opposite in direction. The car la installed at the uppermost side cannot move to the lowermost bottom of the elevator shaft because of the other cars 1b and 1c, and the car 1c installed at the lowermost side cannot move to the uppermost ceiling of the elevator shaft because of the other cars 1a and 1b. Therefore, the section in which the cars 1a, 1b, and 1c may move is shorter than the distance from the ceiling to the bottom of the elevator shaft. Because the section in which the car connection counterweights 21a, 21b, and 21c may move is under the same condition, there is no problem with the traveling of the cars 1a, 1b, and 1c and the car connection counterweights 21a, 21b, and 21c.

The drive device illustrated in FIGS. 10 and 12 may also be applied to the cars 1a, 1b, and 1c in FIG. 36 and operate the cars 1a, 1b, and 1c. In case that the drive device illustrated in FIG. 10 is applied, the one-pulley-built-in drive pulleys 6a, 6b, and 6c illustrated in FIG. 10 is changed to the two-pulley-built-in drive pulleys 7a, 7b, and 7c illustrated in FIG. 15 as described in the detailed description in FIG. 10, the two opposite ends of the drive pulley connection car ropes 2a, 2b, and 2c may be respectively connected to the two pulleys of the drive pulleys 7a, 7b, and 7c. As described in the detailed description in FIG. 10, the change may be additionally performed so that the two drive pulley connection car pulleys 4a may be changed to the fixing rods 13a illustrated in FIG. 12, and the two opposite ends of the car rope 2a may be respectively fixed to the two fixing rods 13a.

In case that the drive device illustrated in FIG. 12 is applied, the one-pulley-built-in drive pulleys 6a, 6b, and 6c illustrated in FIG. 12 is changed to the two-pulley-built-in drive pulleys 7a, 7b, and 7c illustrated in FIG. 15 as described in the detailed description in FIG. 12, the two opposite ends of the drive pulley connection car ropes 2a, 2b, and 2c may be respectively connected to the two pulleys of the drive pulleys 7a, 7b, and 7c. As described in the detailed description in FIG. 12, additionally, the middle portions of the drive pulley connection car ropes 2a, 2b, and 2c may be cut, and the two opposite ends thereof may be fixed.

In this case, the drive pulleys 6a, 6b, 6c, 7a, 7b, and 7c may be actually connected to the traction machine or the like. The traction machine may include the electric motor.

In addition, the cars 1a, 1b, and 1c may move upward or downward in accordance with the rotation directions of the drive pulleys 6a, 6b, 6c, 7a, 7b, and 7c.

The two-pulley-built-in drive pulleys 7a, 7b, and 7c illustrated in FIG. 15 may be applied to the car connection counterweight ropes 22a, 22b, and 22c between the cars 1a, 1b, and 1c and the car connection counterweights 21a, 21b, and 21c illustrated in FIG. 36, and the one-pulley-built-in drive pulleys 6a, 6b, and 6c illustrated in FIG. 20 may be applied. In order to use the one-pulley-built-in drive pulleys 6a, 6b, and 6c, the counterweight rope connection car pulleys 5a, 5b, and 5c may be installed two by two on the cars 1a, 1b, and 1c instead of the counterweight connection fixing rods 11a, 11b, and 11c installed two by two, or the counterweight pulleys 23 may be installed two by two on the car connection counterweights 21a, 21b, and 21c instead of the counterweight fixing rods 20a, 20b, and 20c installed two by two. Further, the counterweight ropes 22a, 22b, and 22c, which are separated two by two, may be connected to one another so as to be disposed one by one, and the drive pulleys 6a, 6b, and 6c may each be connected to one point on each of the counterweight ropes 22a, 22b, and 22c. Further, the counterweight rope connection car pulleys 5a, 5b, and 5c may be installed two by two on the cars 1a, 1b, and 1c instead of the counterweight connection fixing rods 11a, 11b, and 11c installed two by two, the counterweight pulleys 23 may be installed two by two on the car connection counterweights 21a, 21b, and 21c instead of the counterweight fixing rods 20a, 20b, and 20c installed two by two, and the counterweight ropes 22a, 22b, and 22c, which are separated two by two, may be connected to one another so as to define a single ring shape. One point on each of the counterweight ropes 22a, 22b, and 22c may be fixed, or the ring shape is cut so that two opposite ends thereof are respectively fixed to two points. Further, the drive pulleys 6a, 6b, and 6c may each be connected to one point on each of the counterweight ropes 22a, 22b, and 22c.

The two-pulley-built-in drive pulleys 7a, 7b, and 7c may be used in both the case in which the fixing rods 11a, 11b, 11c, 20a, 20b, and 20c are installed and the case in which the pulleys 5a, 5b, 5c, and 23 are installed.

The drive pulleys 7a, 7b, 7c, 6a, 6b, and 6c may be actually connected to the traction machine or the like. The traction machine may include the electric motor.

In addition, the cars 1a, 1b, and 1c may move upward or downward in accordance with the rotation directions of the drive pulleys 7a, 7b, 7c, 6a, 6b, and 6c.

### INDUSTRIAL APPLICABILITY

In the case of the newly installed elevators or the existing elevators, the multi-car elevator according to the present invention may be easily operated by installing the plurality of cars, as necessary, in the elevator shaft in related art and connecting the counterweight rope to the cars.

1. A multi-car elevator comprising:
a counterweight on which one or more counterweight pulleys are installed as movable pulleys; and
a counterweight rope connected to the one or more counterweight pulleys,
wherein the counterweight performs a counterweight function on a plurality of cars through the counterweight rope.

2. The multi-car elevator of claim 1, further comprising:
a counterweight rope connection car pulley or a fixing rod installed on each of the plurality of cars,
wherein the counterweight rope is connected to the counterweight rope connection car pulley or the fixing rod of each of the plurality of cars.

3. The multi-car elevator of claim 1, further comprising:
a counterweight rope connection car pulley or a fixing rod installed on each of the plurality of cars;
a three-pulley-built-in middle pulley, a two-pulley-built-in middle pulley, or a counterweight side middle pulley provided on each of the plurality of cars; and
one or two counterweight rope connection car ropes provided on each of the plurality of cars,
wherein the counterweight rope connection car pulley or the fixing rod and the three-pulley-built-in middle pulley, the two-pulley-built-in middle pulley, or the counterweight side middle pulley of each of the plurality of cars are connected by the one or two counterweight rope connection car ropes of each of the plurality of cars respectively, and
wherein the three-pulley-built-in middle pulley, the two-pulley-built-in middle pulley, or the counterweight side middle pulley of each of the plurality of cars is connected to the counterweight rope respectively.

4. A multi-car elevator comprising:
a car connection counterweight and one or two car connection counterweight ropes provided on each of a plurality of cars;
a counterweight rope connection car pulley or a counterweight connection fixing rod installed on each of the plurality of cars; and
a counterweight pulley or a counterweight fixing rod installed on each of the car connection counterweights,
wherein the counterweight rope connection car pulley or the counterweight connection fixing rod and the counterweight pulley or the counterweight fixing rod of each of the plurality of cars are connected by the one or two car connection counterweight ropes of each of the plurality of cars respectively.

5. The multi-car elevator of claim 2, further comprising:
a drive pulley connection car pulley or a second fixing rod installed on each of the plurality of cars;
a one-pulley-built-in drive pulley or a two-pulley-built-in drive pulley provided on each of the plurality of cars; and
one or two drive pulley connection car ropes provided on each of the plurality of cars,
wherein the drive pulley connection car pulley or the second fixing rod and the one-pulley-built-in drive pulley or the two-pulley-built-in drive pulley of each of the plurality of cars are connected by the one or two drive pulley connection car ropes of each of the plurality of cars respectively.

6. The multi-car elevator of claim 3, further comprising:
a drive pulley connection car pulley or a second fixing rod installed on each of the plurality of cars;
a one-pulley-built-in drive pulley or a two-pulley-built-in drive pulley provided on each of the plurality of cars; and
one or two drive pulley connection car ropes provided on each of the plurality of cars,
wherein the drive pulley connection car pulley or the second fixing rod and the one-pulley-built-in drive pulley or the two-pulley-built-in drive pulley of each of the plurality of cars are connected by the one or two drive pulley connection car ropes of each of the plurality of cars respectively.

7. The multi-car elevator of claim 4, further comprising:
a drive pulley connection car pulley or a second fixing rod installed on each of the plurality of cars;
a one-pulley-built-in drive pulley or a two-pulley-built-in drive pulley provided on each of the plurality of cars; and
one or two drive pulley connection car ropes provided on each of the plurality of cars,
wherein the drive pulley connection car pulley or the second fixing rod and the one-pulley-built-in drive pulley or the two-pulley-built-in drive pulley of each of the plurality of cars are connected by the one or two drive pulley connection car ropes of each of the plurality of cars respectively.

8. The multi-car elevator of claim 2, further comprising:
a differential provided on each of the plurality of cars; and
two drive pulleys connected to two opposite sides of the differential,
wherein the counterweight rope is connected to the two drive pulleys connected to the two opposite sides of the differential of each of the plurality of cars.

9. The multi-car elevator of claim 3, further comprising:
a differential provided on each of the plurality of cars; and
two drive pulleys connected to two opposite sides of the differential,
wherein the one or two counterweight rope connection car ropes are connected to the two drive pulleys connected to the two opposite sides of the differential of each of the plurality of cars.

10. The multi-car elevator of claim 1, further comprising:
a counterweight rope connection car pulley, a drive pulley connection car pulley, or fixing rods installed on each of the plurality of cars;
a three-pulley-built-in middle pulley, a two-pulley-built-in middle pulley, a counterweight side middle pulley, or a car side middle pulley provided on each of the plurality of cars;
one or two counterweight rope connection car ropes or one or two drive pulley connection car ropes provided on each of the plurality of cars; and
a two-pulley-built-in drive pulley or a one-pulley-built-in drive pulley provided on each of the plurality of cars,
wherein the counterweight rope connection car pulley, the drive pulley connection car pulley, or the fixing rod, the two-pulley-built-in drive pulley or the one-pulley-built-in drive pulley, and the three-pulley-built-in middle pulley, the two-pulley-built-in middle pulley, the counterweight side middle pulley, or the car side middle pulley of each of the plurality of cars are connected by the one or two counterweight rope connection car ropes or the one or two drive pulley connection car ropes of each of the plurality of cars respectively,
wherein the three-pulley-built-in middle pulley, the two-pulley-built-in middle pulley, the counterweight side middle pulley, or the car side middle pulley of each of the plurality of cars is connected to the counterweight rope respectively, and
wherein the car side middle pulley of each of the plurality of cars is connected to the counterweight rope through a middle rope and a counterweight side middle pulley of each of the plurality of cars respectively.

11. The multi-car elevator of claim 4, further comprising:
a two-pulley-built-in drive pulley or a one-pulley-built-in drive pulley provided on each of the plurality of cars,
wherein the two-pulley-built-in drive pulleys or the one-pulley-built-in drive pulleys of each of the plurality of cars is connected to the one or two car connection counterweight ropes of each of the plurality of cars respectively.

12. A multi-car elevator, wherein a drive pulley connection car pulley, a counterweight rope connection car pulley, a counterweight connection fixing rod, and a fixing rod, which are configured to be installed on a plurality of cars, are respectively installed on imaginary radial straight lines disposed in different directions based on center vertical lines of the plurality of cars, and installed at positions deviating from edges of the plurality of cars.
